(19) United States
(12) Patent Application Publication
(10) Pub. No.: US 2008/0166495 A1
(43) Pub. Date: Jul. 10, 2008

(54) IMAGE FORMING METHOD AND APPARATUS

(75) Inventors: Yutaka MAENO, Ashigarakami-gun (JP); Tetsuzo Kadomatsu, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/966,470

(22) Filed: Dec. 28, 2007

(30) Foreign Application Priority Data
Dec. 28, 2006 (JP) 2006-355822

(51) Int. Cl. C08F 2/46; B05B 17/00

(52) U.S. Cl. 427/493; 118/641

(57) ABSTRACT

The image forming method includes the steps of: ejecting and depositing an ink containing a coloring material and a radiation polymerizable compound on an intermediate transfer body, the radiation polymerizable compound having a molecular structure including a radical polymerizable group and a cationically polymerizable group; then irradiating the ink on the intermediate transfer body with a first radiation so that one of the radical polymerizable group and the cationically polymerizable group is selectively polymerized and cured; then heating the selectively polymerized and cured ink to a temperature not lower than a softening point of the selectively polymerized and cured ink and not higher than a temperature above the softening point by 10° C., while transferring the selectively polymerized and cured ink from the intermediate transfer body to a recording medium; and then irradiating the ink on the recording medium with a second radiation so that the other of the radical polymerizable group and the cationically polymerizable group is polymerized and cured.

### BACKGROUND OF THE INVENTION

1. Field of the Invention

The present invention relates to an image forming method and apparatus, and more particularly, to an intermediate transfer type of image forming method and apparatus, in which an image is formed on a recording medium by transferring an image (ink image) formed on an intermediate transfer body to the recording medium.

2. Description of the Related Art

There has been known an image forming method based on a so-called intermediate transfer system, in which an image is formed on an intermediate transfer body, and the image formed on the intermediate transfer body is then transferred to a recording medium.

There has also been known an image forming method based on a so-called direct recording system, in which a desired image is formed by ejecting droplets of radiation-curable ink directly onto a recording medium. This method is suitable for recording onto a recording medium (low permeability media or non-permeable media) that has low ink permeability, such as coated papers. However, in the cases of recording media having high permeability (permeable media), such as normal paper, the ink liquid permeates into the recording medium, and image deterioration occurs due to ink bleeding or dot spreading (dot shape abnormality), or the like.

The intermediate transfer type of image forming method is therefore useful for obtaining good images on a variety of media, including permeable media and non-permeable media. However, in an intermediate transfer type of image forming method which uses radiation-curable ink, it is necessary to provisionally fix the ink on the intermediate transfer body, to transfer the ink from the intermediate transfer body to a recording medium, and to fix the ink on the recording medium.

Japanese Patent Application Publication No. 10-250052 discloses a method in which, as a means for provisionally fixing the ink on the intermediate transfer body, a cationically polymerizable ink is semi-cured on the intermediate transfer body, thereby raising the viscosity of the ink, the ink is then transferred to the recording medium, and final curing and fixing is carried out by heating or irradiation of ultraviolet (UV) light. Moreover, Japanese Patent Application Publication No. 2005-161603 discloses a method where, in order to avoid the problems described above, the ink is caused to solidify completely on the intermediate transfer body, whereupon the cured ink material is heated to a glass transition temperature (Tg) or above, and transferred to the recording medium.

However, in the case of the ink which is only raised in viscosity and which remains in a liquid state even after the semi-curing on the intermediate transfer body, as described in Japanese Patent Application Publication No. 10-250052, when transferring the ink to the recording medium, not all of the ink is transferred to the recording medium and a portion of the ink is liable to remain on the intermediate transfer body. The cured ink remaining on the intermediate transfer body is required to be removed before the next printing operation, and therefore the load relating to the cleaning step for the intermediate transfer body increases unless a transfer rate approaching a perfect rate is achieved.

Furthermore, in order to heat and soften the ink having been cured on the intermediate transfer body, as described in Japanese Patent Application Publication No. 2005-161603, it is necessary to reduce the cross-linking ratio of the cured ink, in other words, it is necessary to increase the ratio of monofunctional monomer. However, in the case of an ink having a high monofunctional monomer ratio, the ink having been transferred to the recording medium has a low polymer cross-linking ratio, and consequently the film (i.e., ink film) of the ink on the recording medium has unsatisfactory strength and solvent resistance. Moreover, the ratio of the low molecular weight component (the component having a low degree of polymerization) in the cured ink is high, and residual monomer which has not been polymerized, or low-molecular weight component which has a low degree of polymerization, is liable to migrate out from the ink film after fixed on the recording medium.

### SUMMARY OF THE INVENTION

The present invention has been contrived in view of the foregoing circumstances described above, an object thereof being to provide an image forming method and image forming apparatus of an intermediate transfer type, whereby ink on an intermediate transfer body can be transferred satisfactorily to a recording medium, while achieving good adhesion of the ink to the recording medium and good strength of the ink film as well as preventing the residual monomer in the ink (i.e., the ink film on the recording medium) from migrating out.

In order to attain the aforementioned object, the present invention is directed to an image forming method, comprising the steps of: ejecting and depositing an ink containing a coloring material and a radiation polymerizable compound on an intermediate transfer body, the radiation polymerizable compound having a molecular structure including a radical polymerizable group and a cationically polymerizable group; then irradiating the ink on the intermediate transfer body with a first radiation so that one of the radical polymerizable group and the cationically polymerizable group is selectively polymerized and cured; then heating the selectively polymerized and cured ink to a temperature not lower than a softening point of the selectively polymerized and cured ink and not higher than a temperature above the softening point by 10° C., while transferring the selectively polymerized and cured ink from the intermediate transfer body to a recording medium; and then irradiating the ink on the recording medium with a second radiation so that the other of the radical polymerizable group and the cationically polymerizable group is polymerized and cured.

As a result of thorough research carried out into the problems described above, the present inventors discovered that the problems can be resolved by: provisionally curing the ink on the intermediate transfer body so that the ink is partially polymerized but not cross-linked and has thermoplastic properties; transferring this cured ink from the intermediate transfer body to the recording medium; and then curing the ink on the recording medium so that the ink is cross-linked. In other words, the present inventors discovered that the ink on the intermediate transfer body can be transferred satisfactorily to the recording medium, while achieving good adhesion to the recording medium and good strength of the ink film as well as preventing the residual monomer in the ink from migrating out, by: using the ink containing a polymerizable compound including a radical polymerizable group and a cationically polymerizable group in each molecule; selectively polymerizing and curing one of the groups on the intermediate transfer body; and then transferring the cured ink to the recording medium while heating same in the range from the softening point of the cured ink to the temperature above the softening point by 10° C., and causing the other polymerizable group to become cross-linked.

In this aspect of the present invention, it is possible to provide an image forming method of an intermediate transfer type in which the ink on the intermediate transfer body can be transferred satisfactorily to the recording medium, while achieving good adhesion of the ink to the recording medium and good strength of the ink film, as well as preventing the residual monomer in the ink from migrating out, by means of the image forming method, comprising the steps of: ejecting and depositing an ink containing a coloring material and a radiation polymerizable compound on an intermediate transfer body, the radiation polymerizable compound having a molecular structure including a radical polymerizable group and a cationically polymerizable group; then irradiating the ink on the intermediate transfer body with a first radiation so that one of the radical polymerizable group and the cationically polymerizable group is selectively polymerized and cured; then heating the selectively polymerized and cured ink to a temperature not lower than a softening point of the selectively polymerized and cured ink and not higher than a temperature above the softening point by 10° C., while transferring the selectively polymerized and cured ink from the intermediate transfer body to a recording medium; and then irradiating the ink on the recording medium with a second radiation so that the other of the radical polymerizable group and the cationically polymerizable group is polymerized and cured.

In the present specification, “recording medium” does not only mean a paper as used in a general image forming apparatus, but may also include a cloth, metal, sheet material, glass, ceramic, wood, plastic film, leather, or the like. In a well-known radiation curable inkjet recording method, high quality can be achieved with a medium which is not permeable to the ink or a medium which is slowly permeated with the ink, but when using a medium which is rapidly permeated with the ink (for example, high-grade paper or woody paper), ink bleeding occurs and high quality cannot be obtained. One characteristic feature of the present invention is that high quality can be obtained regardless of the ink permeation characteristics of the recording medium.

Preferably, the one of the radical polymerizable group and the cationically polymerizable group selectively polymerized and cured on the intermediate transfer body is the radical polymerizable group.

More specifically, it is preferable that the radical polymerizable group of the radiation polymerizable compound is selectively polymerized in the initial curing (hereinafter, referred to as “first curing”) on the intermediate transfer body, and the cationically polymerizable group of the radiation polymerizable compound is polymerized in the curing (hereinafter, referred to as “second curing”) on the recording medium.

Preferably, a percentage of a number of the radical polymerizable group in a total number of the radical polymerizable group and the cationically polymerizable group contained in the ink is 60% through 90%.

In this aspect of the present invention, since the number of radical polymerizable groups in the total number of radical polymerizable groups and cationically polymerizable groups is 60% through 90%, then it is possible to provide an image forming method of an intermediate transfer type whereby the ink on the intermediate transfer body can be transferred satisfactorily, while achieving good adhesion of the ink to the recording medium and good strength of the ink film as well as preventing the residual monomer in the ink from migrating out.

Preferably, a number of the radical polymerizable group in the molecular structure of the radiation polymerizable compound is one.

Preferably, the above-described image forming method further comprises the step of applying an undercoat liquid containing the radical polymerizable group on the intermediate transfer body before the step of ejecting and depositing the ink on the intermediate transfer body, wherein a dynamic surface tension γ1(0.1 s) of the undercoat liquid at a surface age of 0.1 seconds and a dynamic surface tension γ2(0.1 s) of the ink at a surface age of 0.1 seconds have a relationship of γ1(0.1 s)<γ2(0.1 s).

In this aspect of the present invention, since the dynamic surface tension γ1 of the undercoat liquid at a surface age of 0.1 seconds and the dynamic surface tension γ2 of the ink at a surface age of 0.1 seconds have a relationship of γ1(0.1 s)<γ2(0.1 s), then it is possible to make the ink droplets having been ejected sink into a layer of undercoat liquid, thereby preventing the coalescence between the adjacent ink droplets on the intermediate transfer body.

Preferably, the radical polymerizable compound includes a compound having a (meth)acryloyl group and a vinylether group, the compound being expressed as follows:

CH₂═CR¹—COO—R²—CH═CH—R³

where R¹ is one of a hydrogen atom and a methyl group; R² is an organic group having 2 to 20 carbon atoms; and R³ is one of a hydrogen atom and an organic group having 1 to 11 carbon atoms.

Preferably, in the step of irradiating the ink with the first radiation, the first radiation is radiated by one of a light-emitting diode and a semiconductor laser.

In this aspect of the present invention, since a light emitting diode or laser diode, which has a narrow full width at half maximum for the light emission wavelength, is used for a radiation source for the initial curing (first curing) on the intermediate transfer body, then the selectivity of the polymerization of only one of the polymerizable groups (i.e., the radical polymerizable group and the cationically polymerizable group) can be improved.

Preferably, in the step of irradiating the ink with the second radiation, the second radiation is radiated by an electron-beam irradiation device.

In this aspect of the present invention, since the curing (second curing) on the recording medium is carried out by means of the electron-beam irradiation device which radiates an electron-beam having a broad emission wavelengths including an absorption wavelength of the initiator for the second curing (in the second curing, it is unnecessary that the light source has a narrow light emission waveband), then it is possible to reduce unreacted polymerizable groups.

In order to attain the aforementioned object, the present invention is also directed to an image forming apparatus comprising: an intermediate transfer body; a liquid ejection device which ejects and deposits droplets of an ink containing a coloring material and a radiation polymerizable compound on the intermediate transfer body, the radiation polymerizable compound having a molecular structure including a radical polymerizable group and a cationically polymerizable group; a liquid supply device which supplies the ink to the liquid ejection device; a first radiation irradiation device which irradiates the ink having been deposited on the intermediate transfer body by the liquid ejection device with a first radiation so that one of the radical polymerizable group and the cationically polymerizable group in the ink is selectively polymerized and cured; a heating device which heats the selectively polymerized and cured ink to a temperature not lower than a softening point of the selectively polymerized and cured ink and not higher than a temperature above the softening point by 10° C.; a pressing device which presses the ink heated by the heating device so that the ink is transferred from the intermediate transfer body to a recording medium; and a second radiation irradiation device which irradiates the ink having been transferred to the recording medium by the pressing device with a second radiation so that the other of the radical polymerizable group and the cationically polymerizable group is polymerized and cured.

According to the present invention, it is possible to provide an image forming method and image forming apparatus of an intermediate transfer type, whereby ink on an intermediate transfer body can be transferred satisfactorily to a recording medium, while achieving good adhesion of the ink to the recording medium and good strength of the ink film as well as preventing the residual monomer in the ink from migrating out.

### BRIEF DESCRIPTION OF THE DRAWINGS

The nature of the present invention, as well as other objects and benefits thereof, will be explained in the following with reference to the accompanying drawings, in which like reference characters designate the same or similar parts throughout the figures and wherein:

FIG. 1 is a schematic drawing of an inkjet recording apparatus according to a first embodiment of the present invention;

FIGS. 2A to 2C are plan view perspective diagrams showing examples of the composition of a print head;

FIG. 3 is a cross-sectional view along line 3-3 in FIGS. 2A and 2B;

FIG. 4 is an approximate diagram showing the composition of an ink supply system of the inkjet recording apparatus shown in FIG. 1;

FIG. 5 is a principal block diagram showing the system configuration of the inkjet recording apparatus shown in FIG. 1;

FIG. 6 is an illustrative diagram showing an example of a set of polymerization initiators having different absorption wavelengths;

FIG. 7 is a schematic drawing of an inkjet recording apparatus according to a second embodiment of the present invention;

FIG. 8 is a schematic drawing of an inkjet recording apparatus according to a third embodiment of the present invention; and

FIGS. 9 to 13 are diagrams showing the evaluation results of practical examples.

### DETAILED DESCRIPTION OF THE PREFERRED EMBODIMENTS

An embodiment of the present invention is directed to an image forming apparatus including: an intermediate transfer body; a liquid ejection device which ejects and deposits droplets of an ink containing a coloring material and a radiation polymerizable compound on the intermediate transfer body, the radiation polymerizable compound having a molecular structure including a radical polymerizable group and a cationically polymerizable group; a liquid supply device which supplies the ink to the liquid ejection device; a first radiation irradiation device which irradiates the ink having been deposited on the intermediate transfer body by the liquid ejection device with a first radiation so that one of the radical polymerizable group and the cationically polymerizable group in the ink is selectively polymerized and cured; a heating device which heats the selectively polymerized and cured ink to a temperature not lower than a softening point of the selectively polymerized and cured ink and not higher than a temperature above the softening point by 10° C.; a pressing device which presses the ink heated by the heating device so that the ink is transferred from the intermediate transfer body to a recording medium; and a second radiation irradiation device which irradiates the ink having been transferred to the recording medium by the pressing device with a second radiation so that the other of the radical polymerizable group and the cationically polymerizable group is polymerized and cured.

### First Embodiment

### Composition of Image Forming Apparatus

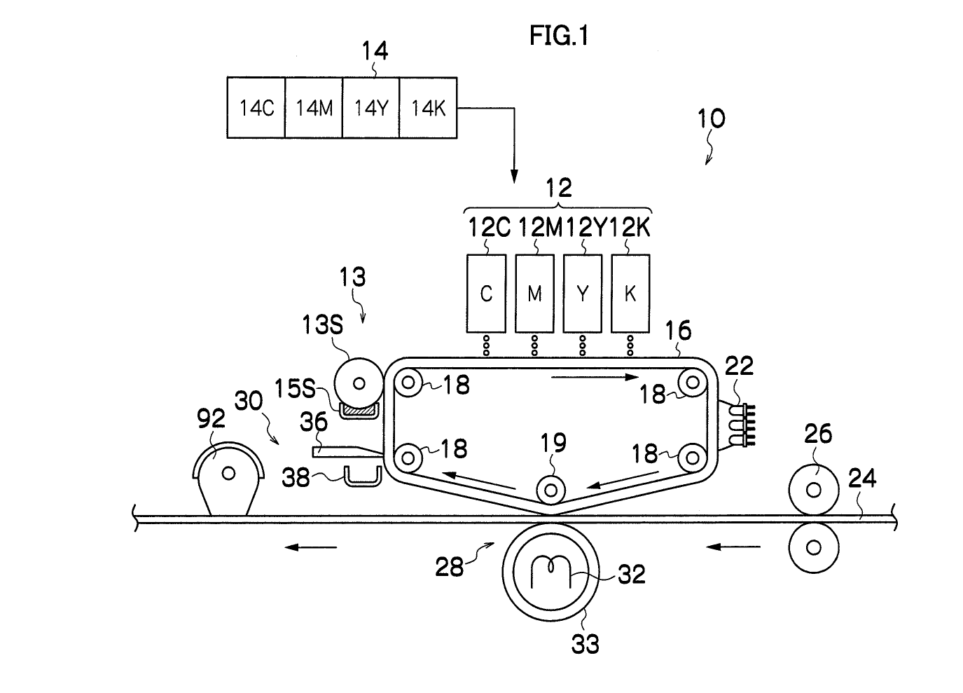

FIG. 1 is a schematic drawing of an inkjet recording apparatus as an image forming apparatus according to a first embodiment of the present invention. As shown in FIG. 1, the inkjet recording apparatus 10 includes: a print unit 12 having a plurality of inkjet heads (hereinafter called “heads”) 12C, 12M, 12Y and 12K corresponding to inks of respective colors of cyan (C), magenta (M), yellow (Y) and black (K); an ink storing and loading unit 14, which stores inks to be supplied to the respective heads 12C, 12M, 12Y and 12K; and an intermediate transfer body 16, on which an image (primary image) is formed by means of inks ejected as droplets from the heads 12C, 12M, 12Y and 12K.

The inks used in the present embodiment are radiation-curable inks, each of which contains a radiation polymerizable compound and a coloring material (e.g., pigment) of the corresponding color. The details of the ink composition are described hereinafter.

The ink storing and loading unit 14 has ink tanks 14C, 14M, 14Y, and 14K, for storing the inks of K, C, M and Y to be supplied to the heads 12C, 12M, 12Y and 12K, and the tanks are connected to the heads 12C, 12M, 12Y and 12K by means of prescribed flow channels. The ink storing and loading unit 14 has a warning device (for example, a display device or an alarm sound generator) for warning when the remaining amount of any ink is low, and has a mechanism for preventing loading errors among the colors.

In other words, the heads 12C, 12M, 12Y and 12K of the print unit 12 correspond to the “liquid ejection device”, and the ink storing and loading unit 14 and the flow channels of the supply system correspond to the “liquid supply device”.

As shown in FIG. 1, an endless belt member is used for the intermediate transfer body 16. The intermediate transfer body 16, which is made of an endless belt member, is wound around a plurality of spanning rollers 18 and a transfer pressurization opposition roller 19, and at least the portion of the belt surface which opposes the nozzle face (ink ejection face) of the print unit 12 and on which a primary image is formed by the print unit 12, is configured to have a horizontal surface (flat surface). Moreover, the whole of the intermediate transfer body 16 or at least a portion of the belt surface which includes the image forming region where deposition of ink ejected by the print unit 12 is intended (predicted), is made of a material that is not permeable (non-permeable) to the liquid droplets, such as resin or metal.

By transmitting the motive force of a motor (not shown in FIG. 1 and indicated by reference numeral 88 in FIG. 5) to at least one of the plurality of spanning rollers 18 and the opposition roller 19 about which the intermediate transfer body 16 is wound, the intermediate transfer body 16 is driven in the clockwise direction in FIG. 1.

The respective heads 12C, 12M, 12Y and 12K of the print unit 12 are each full-line heads having a length corresponding to the maximum width of the image forming region on the intermediate transfer body 16 (the image forming region). In each of the heads (full-line heads) 12C, 12M, 12Y and 12K, a plurality of nozzles for ejecting ink are arranged in the nozzle face of the head through the full width of the image forming region.

The heads 12C, 12M, 12Y and 12K are arranged following the conveyance direction of the intermediate transfer body 16, in the color order, cyan (C), magenta (M), yellow (Y) and black (K), from the upstream side in terms of the conveyance direction, and these respective heads 12C, 12M, 12Y and 12K are fixed so as to extend in a direction perpendicular to the conveyance direction of the intermediate transfer body 16.

An image (primary image) can be formed on the intermediate transfer body 16 by ejecting the inks from the heads 12C, 12M, 12Y and 12K, respectively, onto the intermediate transfer body 16 while conveying the intermediate transfer body 16.

By adopting a configuration in which full line heads 12C, 12M, 12Y and 12K having nozzle rows covering the full width of the intermediate transfer body 16 are provided for each separate color in this way, it is possible to record an image on the image forming region of the intermediate transfer body 16 by performing just one operation of moving the intermediate transfer body 16 and the print unit 12, relatively, in the conveyance direction (the sub-scanning direction) of the intermediate transfer body 16 (in other words, by means of one sub-scanning action). Higher-speed printing is thereby made possible and print productivity can be improved in comparison with a serial (shuttle) type head configuration in which a head moves reciprocally in a direction which is perpendicular to the conveyance direction.

Although a configuration with the four standard colors of C, M, Y and K is described in the present embodiment, the combinations of the ink colors and the number of colors are not limited to those. Light and/or dark inks, and special color inks can be added as required. For example, a configuration is possible in which inkjet heads for ejecting light-colored inks, such as light cyan and light magenta, are added, and there is no particular restriction on the arrangement sequence of the heads of the respective colors.

Furthermore, the inkjet recording apparatus 10 includes: a first radiation source 22 for curing (performing first curing operation) the ink by applying radiation onto the ink deposited on the intermediate transfer body 16; a pair of media conveyance rollers 26 for supporting and conveying a recording medium 24; a transfer unit 28 for transferring a primary image on the intermediate transfer body 16, to the recording medium 24 conveyed by the nip of the pair of media conveyance rollers 26; a second radiation source 92 for further curing (performing second curing operation) the image (the ink) having been transferred on the recording medium 24; and a cleaning unit 30 for removing the remaining ink deposited onto the intermediate transfer body 16, after transfer.

According to the composition described above, a primary image is formed on the intermediate transfer body 16 by depositing ink ejected from the heads 12C, 12M, 12Y and 12K of the print unit 12, onto the intermediate transfer body 16. With the movement of the intermediate transfer body 16, this primary image is moved in the clockwise direction in FIG. 1, and the primary image is irradiated with the radiation applied from the first radiation source 22.

It is preferable that the inkjet recording apparatus 10 further includes an undercoat liquid applying unit 13 for applying undercoat liquid 15S onto the intermediate transfer body 16 before the droplets of the ink ejected from the heads 12C, 12M, 12Y and 12K of the print unit 12 are deposited on the intermediate transfer body 16.

The ink and the undercoat liquid on the intermediate transfer body 16 are polymerized and cured by the radiation (energy) applied from the first radiation source 22, and are thereby fixed provisionally onto the intermediate transfer body 16 in the state of a cured ink material. The amount of radiation applied (the energy density and the irradiation time) is controlled with a view to applying the energy required for curing the ink.

It is necessary that this irradiation operation selectively polymerizes and cures the one of the radical polymerizable group and the cationically polymerizable group in the ink droplets on the intermediate transfer body 16, in order for the ink on the intermediate transfer body to be transferred to the recording medium in a substantially complete fashion. It is undesirable that the liquid ink droplets are polymerized in the first curing operation but are not cured completely and are in an intermediate state of increased viscosity, since a so-called “offset” phenomenon is liable to arise in which the ink remains on the intermediate transfer body as well as the recording medium.

The transfer unit 28 is provided on one side of the intermediate transfer body 16 opposite to the other side on which the flat image forming region facing the print unit 12 is arranged (in FIG. 1, the transfer unit 28 is provided in a position directly below the image forming region). A transfer heating roller 33 having a heater 32 is disposed in the transfer unit 28, and the intermediate transfer body 16 and the recording medium 24 are interposed between the transfer heating roller 33 and the pressurization nip opposition roller 19 which is disposed opposing the transfer heating roller 33, thereby pressurizing the intermediate transfer body 16 and the recording medium 24 at a prescribed pressure (nip pressure) while heating same to a prescribed temperature (a temperature in the range from the softening point of the cured matter (i.e., the ink) to the temperature above the softening point by 10° C.), in such a manner that the primary image on the intermediate transfer body 16 is transferred to the recording medium 24. In other words, in the present embodiment, the transfer heating roller 33 having the heater 32 corresponds to a “heating device”, and the combination of this transfer pressurization roller 33 and the opposition roller 19 corresponds to a “pressing device”.

In order to adjust the nip pressure during transfer, for example, a mechanism (drive device) which moves the transfer heating roller 33 upwards and downwards in FIG. 1 is provided.

The ink is thus transferred and formed on the recording medium 24 through the transfer unit 28, and is fully fixed by the second radiation source 92. The second radiation source 92 polymerizes and cures the other of the radical polymerizable group and the cationically polymerizable group in the ink and the undercoat liquid that group has not been polymerized and cured by the first radiation source 22.

The printed object thus generated (the recording medium 24 formed with an image) is outputted from a print output section (not shown).

Concrete examples of the recording medium 24 includes: a permeable paper, such as a normal paper, a special inkjet paper or the like; a non-permeable or low-permeability media, such as a coated paper; a sealing paper which has adhesive and a detachable label attached to the rear surface; a resin film such as an OHP sheet; and other types of media including a metal sheet, cloth, and wood.

Although not shown in FIG. 1, for the composition of the paper supply unit which supplies the recording medium 24, it is possible to adopt a mode including a magazine for rolled paper (continuous paper), or a mode in which paper is supplied by means of a cassette in which cut paper is stacked and loaded, instead of or in conjunction with the rolled paper. In the case of a configuration in which roll paper is used, a cutter is provided and the continuous paper is cut to a desired size by the cutter. It is also possible to use jointly a plurality of magazines or cassettes containing papers of different widths and qualities, and the like.

In the case of a configuration in which a plurality of types of recording medium can be used, it is preferable that an information recording medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

Furthermore, the cleaning unit 30 which functions as a device for cleaning the intermediate transfer body 16 after transfer includes a blade 36 which removes residual ink while abutting against the intermediate transfer body 16 and a recovery unit 38 which recovers the residual ink thus removed. The composition of the cleaning device which removes the residual ink from the intermediate transfer body 16 is not limited to the embodiment given above, and it may adopt, for example, a configuration in which the intermediate transfer body 16 is nipped with a brush roller, a water absorbent roller or the like, or an air blowing configuration in which clean air is blown onto the intermediate transfer body 16, or a combination of these. In the case of a configuration in which the intermediate transfer body 16 is nipped with a cleaning roller, it is preferable to make the linear velocity of the cleaning roller different to that of the intermediate transfer body 16, in order to improve the cleaning effect.

### Structure of Head

Next, the structure of a head is described below. The heads 12C, 12M, 12Y and 12K of the respective ink colors have the same structure, and a reference numeral 50 is hereinafter designated to any of the heads.

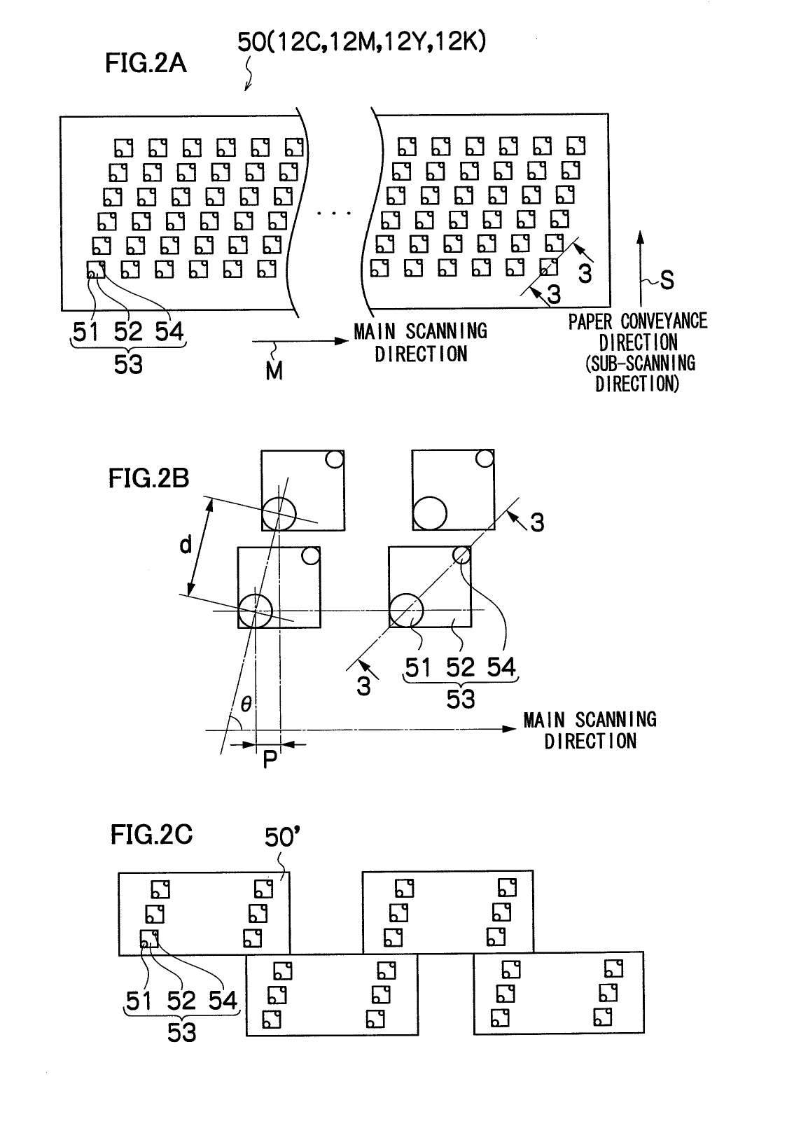

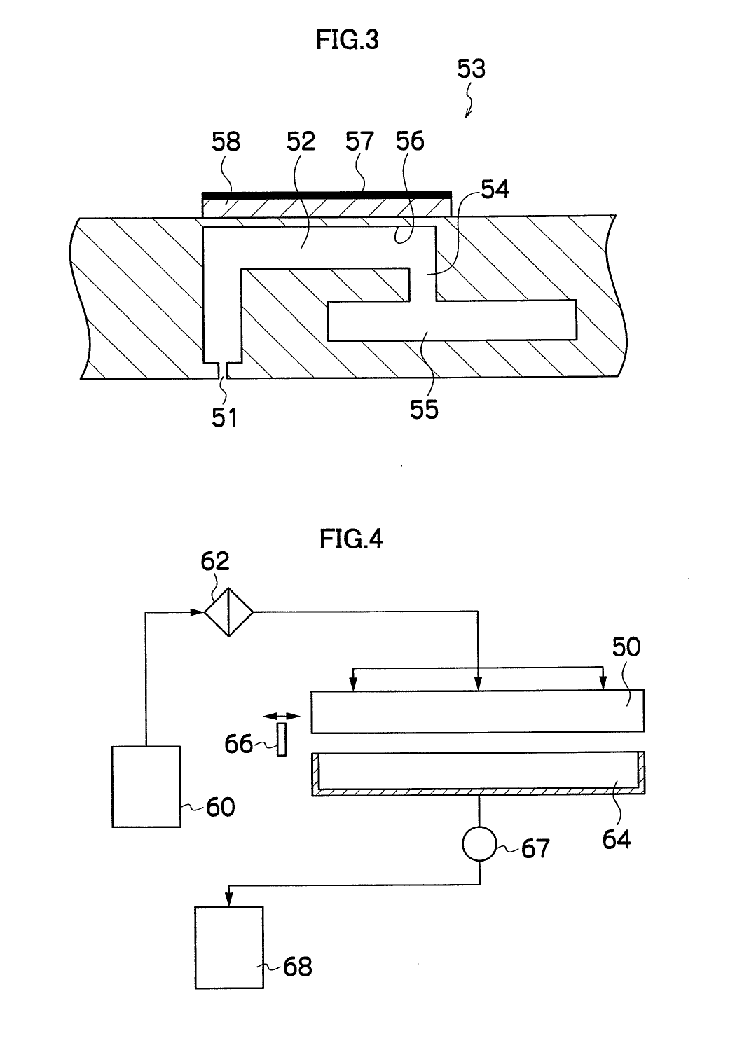

FIG. 2A is a plan view perspective diagram showing an example of the structure of a head 50, and FIG. 2B is an enlarged diagram of a portion of same. As shown in FIGS. 2A and 2B, this print head 50 has a structure in which a plurality of pressure chamber units (liquid droplet ejection elements) 53 are arranged in a matrix configuration (two-dimensionally), each pressure chamber unit including a nozzle 51 which ejects ink in the form of a droplet, a pressure chamber 52 corresponding to the nozzle 51, and an independent supply port 54 for supplying ink to the respective pressure chamber 52 from a common flow channel 55 for ink supply (not shown in FIGS. 2A and 2B, but shown in FIG. 3).

As shown in FIGS. 2A and 2B, the planar shape of the pressure chamber 52 provided corresponding to each nozzle 51 is substantially a square shape, and an outlet port to the nozzle 51 is provided at one of the ends of the diagonal line of the planar shape, while an independent supply port 54 is provided at the other end thereof. The shape of the pressure chamber 52 is not limited to that of the present example and various modes are possible in which the planar shape is a quadrilateral shape (rhombic shape, rectangular shape, or the like), a pentagonal shape, a hexagonal shape, or other polygonal shape, or a circular shape, elliptical shape, or the like.

By adopting a composition in which a plurality of pressure chamber units 53 having the composition described above are arranged in a lattice configuration according to a fixed arrangement pattern following a row direction in line with the lengthwise direction of the head (the direction of arrow M in FIG. 2A), and an oblique column direction having a fixed non-perpendicular angle θ with respect to the row direction, then high-density nozzle rows are achieved in which the effective nozzle pitch (projected nozzle pitch) when projected to an alignment in the lengthwise direction of the head (direction of arrow M) is a narrow pitch.

The mode of forming one or more nozzle rows through a length corresponding to the entire width of the recording medium 20 in a direction substantially perpendicular to the conveyance direction of the recording medium 20 (the direction of arrow S in FIG. 2A) is not limited to the example described above. For example, instead of the configuration in FIG. 2A, as shown in FIG. 2C, a line head having nozzle rows of a length corresponding to the entire width of the recording medium can be formed by arranging and combining, in a staggered matrix, short head module 50′ having a plurality of nozzles 51 arrayed in a two-dimensional fashion.

FIG. 3 is a cross-sectional diagram showing the three-dimensional composition of an ink chamber unit 53 (a cross-sectional diagram along line 3-3 in FIGS. 2A and 2B). As shown in FIG. 3, each pressure chamber 52 is connected to the common flow channel 55 through an individual supply port 54. Each common flow channel 55 is connected to one of the ink tanks (not shown in FIG. 3, but shown and denoted with reference numerals 14C, 14M, 14Y and 14K in FIG. 1), which are base tanks that supply ink, and the ink supplied from the ink tank is delivered through the common flow channel 55 in FIG. 3 to the pressure chambers 52.

Desirably, a uniform film is formed inside the ink flow channels, principally, in the pressure chambers, for example, a coating of polyparaxylylene (product name, parylene) is provided.

An actuator 58 provided with an individual electrode 57 is bonded to a pressure plate (a diaphragm that also serves as a common electrode) 56 which forms the surface of one portion (in FIG. 3, the ceiling) of the pressure chambers 52. When a drive voltage is applied to the individual electrode 57 and the common electrode, the actuator 58 deforms, thereby changing the volume of the pressure chamber 52. This causes a pressure change which results in ink being ejected from the nozzle 51. For the actuator 58, it is possible to adopt a piezoelectric element using a piezoelectric body, such as lead zirconate titanate, barium titanate, or the like. When the displacement of the actuator 58 returns to its original position after ejecting ink, the pressure chamber 52 is replenished with new ink from the common flow channel 55 through the independent supply port 54.

By controlling the driving of the actuators 58 corresponding to the nozzles 51 in accordance with the dot data generated from the data of the input image (original data of image to be printed), it is possible to eject ink droplets from the nozzles 51.

### Configuration of Ink Supply System

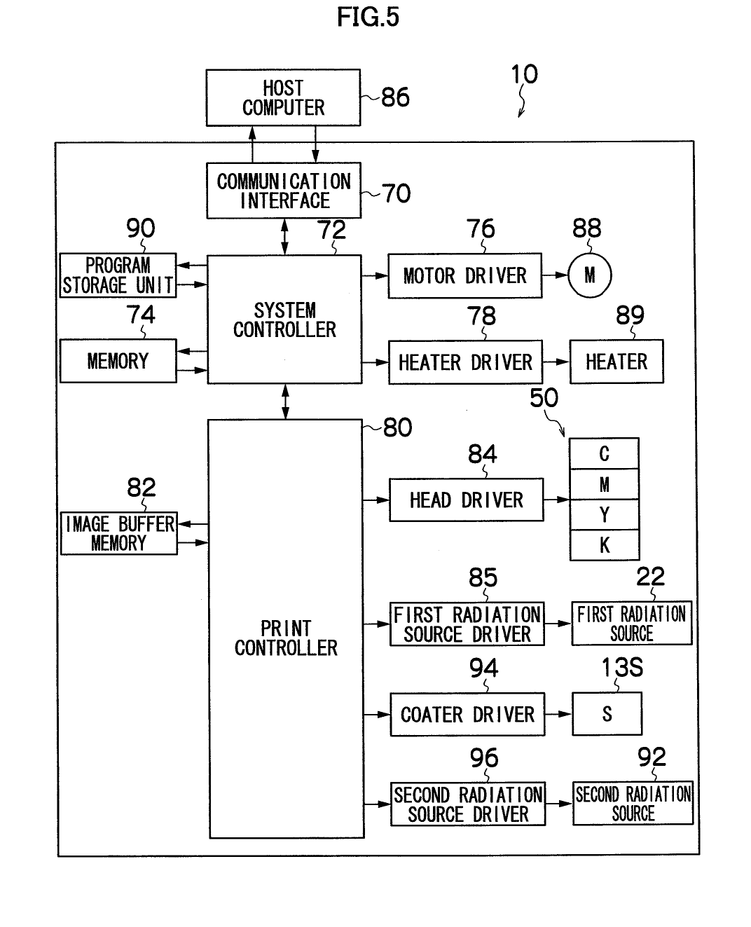

FIG. 4 is a schematic drawing showing the configuration of the ink supply system in the inkjet recording apparatus 10. The ink tank 60 in FIG. 4 is a base tank that supplies ink to the head 50 and is set in the ink storing and loading unit 14 described with reference to FIG. 1. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code, a wireless tag or the like on the cartridge, and to perform ejection control in accordance with the ink type.

A filter 62 for removing foreign matters and bubbles is disposed in a flow channel between the ink tank 60 and the head 50 as shown in FIG. 4. The filter mesh size in the filter 62 is preferably equivalent to or less than the diameter of the nozzle and commonly about 20 μm. Although not shown in FIG. 4, it is preferable to provide a sub-tank integrally to the print head 50 or nearby the head 50. The sub-tank has a damper function for preventing variation in the internal pressure of the head and a function for improving refilling of the print head.

Furthermore, the inkjet recording apparatus 10 is provided with a cap 64 forming a device for preventing increased viscosity and curing of ink on the nozzle face due to scattered light entered into the nozzles 51, and a cleaning blade 66 forming a nozzle surface cleaning device. A maintenance unit including the cap 64 and the cleaning blade 66 can be relatively moved with respect to the head 50 by a movement mechanism (not shown), and is moved from a predetermined holding position to a maintenance position below the head 50 as required.

The cap 64 is displaced up and down relatively with respect to the head 50 by an elevator mechanism (not shown). When the power of the inkjet recording apparatus 10 is turned OFF or when in a print standby state, the cap 64 is raised to a predetermined elevated position so as to come into close contact with the head 50, and the nozzle face is thereby covered with the cap 64.

The cleaning blade 66 is composed of rubber or another elastic member, and can slide on the ink ejection face (surface of the nozzle plate) of the head 50 by means of a blade movement mechanism (not shown). When ink droplets or foreign matters have adhered to the nozzle plate, the surface of the nozzle plate is wiped and cleaned by sliding the cleaning blade 66 on the nozzle plate.

During printing or during standby, if the use frequency of a particular nozzle has declined and the ink viscosity in the vicinity of that nozzle has increased, or the like, then according to requirements, a preliminary ejection (also called “dummy ejection”, “purge”, “spit ejection”, or the like) is performed toward the cap 64, in order to remove the degraded ink.

Moreover, if air bubbles become intermixed into the nozzles 51 and the pressure chambers 52, or if the increase in the viscosity of the ink inside the nozzles 51 has exceeded a certain level, then it becomes difficult to eject ink by means of preliminary ejection as described above, and in cases of this kind, the cap 64 is caused to come into contact with the nozzle surface of the head 50, and the ink inside the pressure chambers 52 (the ink into which air bubbles have become intermixed or ink of increased viscosity) is removed by suctioning by means of a suction pump 67. The ink suctioned and removed by means of this suction operation is sent to a recovery tank 68. The recovered liquid may be discarded or it may be reused.

### Description of Control System

FIG. 5 is a principal block diagram showing the system configuration of the inkjet recording apparatus 10. The inkjet recording apparatus 10 includes a communication interface 70, a system controller 72, an image memory 74, a motor driver 76, a heater driver 78, a print controller 80, an image buffer memory 82, a head driver 84, a first radiation source driver 85, a coater driver 94, a second radiation source driver 96, and the like.

The communication interface 70 is an interface (image input device) unit for receiving image data sent from a host computer 86. A serial interface such as USB (Universal Serial Bus), IEEE1394, Ethernet (registered trademark), wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74.

The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is constituted of a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 72 controls the various sections, such as the communication interface 70, image memory 74, motor driver 76, heater driver 78, and the like, as well as controlling communications with the host computer 86 and writing and reading to and from the image memory 74, and it also generates control signals for controlling other motor 88 and heater 89 of the conveyance system.

Here, the motor 88 includes a motor which applies a motive force to the spanning rollers 18 described in FIG. 1, a motor which applies a motive force to the pair of media conveyance rollers 26, or a motor for adjusting the nip pressure between the opposition roller 19 and the transfer heating roller 33 in the transfer unit 28, and the like.

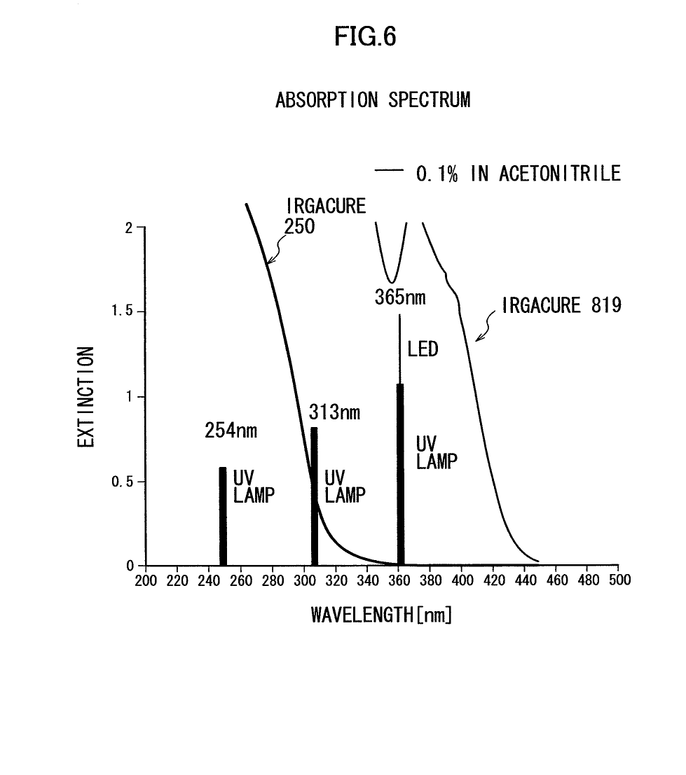

Moreover, the heater 89 shown in FIG. 6 includes, for example, the heater 32 inside the transfer heating roller 33 shown in FIG. 1, a heater for adjusting the temperature inside the head 50, and the like.

The program storage unit 90 shown in FIG. 6 stores various programs executed by the CPU of the system controller 72 and various data required for control procedures, and it reads out and executes programs in accordance with instructions from the system controller 72. The program storage unit 90 may be a non-rewriteable storage device such as a ROM, or it may be a rewriteable storage device, such as an EEPROM. The image memory 74 is used as a temporary storage region for the image data, and it is also used as a program development region and a calculation work region for the CPU.

The motor driver (drive circuit) 76 drives the motor 88 in accordance with commands from the system controller 72. The heater driver (drive circuit) 78 drives the heater 89 in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print data (dot data) to the head driver 84 and the coater driver 94. Prescribed signal processing is carried out in the print controller 80, and the ejection amount and the ejection timing of the ink droplets from the respective print heads 50 are controlled through the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. Also possible is an aspect in which the print controller 80 and the system controller 72 are integrated to form a single processor.

The head driver 84 drives the actuators 58 of the heads of the respective colors 12C, 12M, 12Y and 12K on the basis of print data supplied from the print controller 80. The head driver 84 can be provided with a feedback control system for maintaining constant drive conditions for the print heads.

To give a general description of the sequence of processing from image input to print output, image data to be printed (original image data) is input from an external source through a communication interface 70, and is accumulated in the image memory 74. At this stage, RGB image data is stored in the image memory 74, for example.

In this inkjet recording apparatus 10, an image which appears to have continuous tonal graduations to the human eye is formed by changing the droplet ejection density and the dot size of fine dots created by ink (coloring material), and therefore, it is necessary to convert the input digital image into a dot pattern which reproduces the tonal graduations of the image (namely, the light and shade toning of the image) as faithfully as possible. Therefore, original image data (RGB data) stored in the image memory 74 is sent to the print controller 80 through the system controller 72, and is converted to the dot data for each ink color by a half-toning technique, using dithering, error diffusion, or the like, in the print controller 80.

In other words, the print controller 80 performs processing for converting the input RGB image data into dot data for the four colors of K, C, M and Y. The dot data generated by the print controller 80 in this way is stored in the image buffer memory 82.

The head driver 84 outputs drive signals for driving the actuators 58 corresponding to the respective nozzles 51 of the print head 50, on the basis of the dot data of the respective colors supplied from the print controller 80 (in other words, the ink dot data stored in the image buffer memory 82). In other words, the combination of the print controller 80 and the head driver 84 corresponds to the drive control device of the head 50.

The undercoat liquid applying unit 13 applies the undercoat liquid 15S with an application roller 13S onto the intermediate transfer body 16 according to the drive signals outputted by the coater driver 94.

Moreover, by supplying the drive signals output by the head driver 84 to the print head 50, ink is ejected from the corresponding nozzles 51. By controlling ink ejection from the heads 50 in synchronization with the conveyance speed of the intermediate transfer body 16, an image is formed on the intermediate transfer body 16.

As described above, the ejection volume and the ejection timing of the liquid droplets from the head 50 are controlled, on the basis of the dot data generated by implementing prescribed signal processing in the print controller 80. By this means, prescribed dot sizes and dot positions can be achieved.

Further, the print controller 80 controls the first radiation source (e.g., ultraviolet light source) 22 through the first radiation source driver 85. In other words, the first radiation source driver 85 controls the on/off switching, the irradiation amount, the irradiation time, and the like, of the first radiation source 22, in conjunction with the control of the conveyance of the intermediate transfer body 16, on the basis of control signals sent from the print controller 80 to the first radiation source driver 85.

Furthermore, the print controller 80 controls the second radiation source (e.g., ultraviolet light source) 92 through the second radiation source driver 96. In other words, the second radiation source driver 96 controls the on/off switching, the irradiation amount, the irradiation time, and the like, of the second radiation source 92, in conjunction with the control of the conveyance of the intermediate transfer body 16, on the basis of control signals sent from the print controller 80 to the second radiation source driver 96.

### Description of Ink

Next, the ink used in the inkjet recording apparatus according to the present embodiment is described in detail below. The inkjet recording apparatus according to the present embodiment uses an ink set including inks of respective colors, each of which contains a polymerization initiator, a radiation polymerizable compound, and a coloring material (colorant). In particular, in the present embodiment, a completely curable type of ink is used which contains no water (non-polymerizable solvent component). Moreover, the radiation polymerizable compound has at least the radical polymerizable group and the cationically polymerizable group in each molecule.

### Compound Having Radical Polymerizable Group and Cationically Polymerizable Group

The compound including a radical polymerizable group and a cationically polymerizable group used in the present invention will now be described. For example, a compound having a molecular structure that includes both a (meth)acryloyl group and a vinyl ether group may be used for the compound having a radical polymerizable group and a cationically polymerizable group, and it is possible to adopt a compound which has at least one or more (meth)acryloyl group and vinyl ether group in each molecule. In the present specification, the term “(meth)acryloyl” indicates “acryloyl” and/or “methacryloyl”. Preferred example of the compound is a (meth)acrylic acid ester containing a vinyl ether group, which is expressed by the following general formula (1):

CH═CR—COO—R²—CH═CH—R³ (1),

where R¹ is a hydrogen atom or a methyl group; R² is an organic group having 2 to 20 carbon atoms; and R³ is a hydrogen atom or an organic group having 1 to 11 carbon atoms.

In the general formula (1) described above, the organic group represented by R² is desirably: a straight-chain, branched or cyclic alkylene group having 2 to 20 carbon atoms; an alkylene group having 2 to 20 carbon atoms and having an oxygen atom in its structure by means of an ether bond and/or ester bond; or an aromatic group in which 6 to 11 carbon atoms may be substituted. Of these, it is appropriate to use an alkylene group having 2 to 6 carbon atoms, or an alkylene group having 2 to 9 carbon atoms and having an oxygen atom in its structure by means of an ether bond.

In the general formula (1) described above, desirably, the organic group having 1 to 11 carbon atoms represented by R³ is either a straight-chain, branched or cyclic alkyl group having 1 to 10 carbon atoms, or an aromatic group in which 6 to 11 carbon atoms may be substituted. Of these, it is desirable to use an alkyl group having 1 to 2 carbon atoms, or an aromatic group having 6 to 8 carbon atoms.

Preferred examples of the (meth)acrylic acid ester containing a vinyl ether group represented by the general formula (1) above include: 2-vinyloxy ethyl (meth)acrylate; 3-vinyloxy propyl (meth)acrylate; 1-methyl-2-vinyloxy ethyl (meth)acrylate; 2-vinyloxy propyl (meth)acrylate; 4-vinyloxy butyl (meth)acrylate; 1-methyl-3-vinyloxy propyl (meth)acrylate; 1-vinyloxy methyl propyl (meth)acrylate; 2-methyl-3-vinyloxy propyl (meth)acrylate; 1,1-dimethyl-2-vinyloxy ethyl (meth)acrylate; 3-vinyloxy butyl (meth)acrylate; 1-methyl-2-vinyloxy propyl (meth)acrylate; 2-vinyloxy butyl (meth)acrylate; 4-vinyloxy cyclohexyl (meth)acrylate; 6-vinyloxy hexyl (meth)acrylate; 4-vinyloxy methyl cyclohexyl methyl (meth)acrylate; 3-vinyloxy methyl cyclohexyl methyl (meth)acrylate; 2-vinyloxy methyl cyclohexyl methyl (meth)acrylate; p-vinyloxy methyl phenyl methyl (meth)acrylate; m-vinyloxy methyl phenyl methyl (meth)acrylate; and o-vinyloxy methyl phenyl methyl (meth)acrylate.

Moreover, other preferred examples of the (meth)acrylic acid ester containing a vinyl ether group represented by the general formula (1) above include: 2-(vinyloxy ethoxy) ethyl (meth)acrylate; 2-(vinyloxy isobutoxy) ethyl (meth)acrylate; 2-(vinyloxy ethoxy) propyl (meth)acrylate; 2-(vinyloxy ethoxy) isopropyl (meth)acrylate; 2-(vinyloxy isopropoxy) propyl (meth)acrylate; 2-(vinyloxy isopropoxy) isopropyl (meth)acrylate; 2-(vinyloxy ethoxy ethoxy) ethyl (meth)acrylate; 2-(vinyloxy ethoxy isopropoxy) ethyl (meth)acrylate; 2-(vinyloxy isopropoxy ethoxy) ethyl (meth)acrylate; 2-(vinyloxy isopropoxy isopropoxy) ethyl (meth)acrylate; 2-(vinyloxy ethoxy ethoxy) propyl (meth)acrylate; 2-(vinyloxy ethoxy isopropoxy) propyl (meth)acrylate; 2-(vinyloxy isopropoxy ethoxy) propyl (meth)acrylate; 2-(vinyloxy isopropoxy isopropoxy) propyl (meth)acrylate; 2-(vinyloxy ethoxy ethoxy) isopropyl (meth)acrylate; 2-(vinyloxy ethoxy isopropoxy) isopropyl (meth)acrylate; 2-(vinyloxy isopropoxy ethoxy) isopropyl (meth)acrylate; 2-(vinyloxy isopropoxy isopropoxy) isopropyl (meth)acrylate; 2-(vinyloxy ethoxy ethoxy ethoxy) ethyl (meth)acrylate; 2-(vinyloxy ethoxy ethoxy ethoxy ethoxy) ethyl (meth)acrylate; 2-(isopropenoxy ethoxy) ethyl (meth)acrylate; 2-(isopropenoxy ethoxy ethoxy) ethyl (meth)acrylate; 2-(isopropenoxy ethoxy ethoxy ethoxy) ethyl (meth)acrylate; 2-(isopropenoxy ethoxy ethoxy ethoxy ethoxy) ethyl (meth)acrylate; (meth)acrylic acid-polyethylene glycol monovinyl ether; and (meth)acrylic acid-polypropylene glycol monovinyl ether.

Of these, preferable examples include: 2-vinyloxy ethyl (meth)acrylate; 3-vinyloxy propyl (meth)acrylate; 1-methyl-2-vinyloxy ethyl (meth)acrylate; 2-vinyloxy propyl (meth)acrylate; 4-vinyloxy butyl (meth)acrylate; 4-vinyloxy cyclohexyl (meth)acrylate; 5-vinyloxy pentyl (meth)acrylate; 6-vinyloxy hexyl (meth)acrylate; 4-vinyloxy methyl cyclohexyl methyl (meth)acrylate; p-vinyloxy methyl phenyl methyl (meth)acrylate; 2-(vinyloxy ethoxy) ethyl (meth)acrylate; 2-(vinyloxy ethoxy ethoxy) ethyl (meth)acrylate; and 2-(vinyloxy ethoxy ethoxy ethoxy) ethyl (meth)acrylate.

As the actual compounds for use in the present invention, 2-(2-vinyloxy ethoxy) ethyl acrylate (manufactured by Nippon Shokubai Co., Ltd) and 2-(2-vinyloxy ethoxy) ethyl methacrylate (manufactured by Nippon Shokubai Co., Ltd) are commercially available.

### Radiation Polymerizable Compound

The radiation polymerizable compound in the present invention has a curing function by generating a polymerization or bridging reaction by means of initiators, such as radicals generated from the polymerization initiator, or the like, described below.

The radiation polymerizable compound used in the present invention may be a commonly known radiation polymerizable compound using a radical polymerization reaction, a cationic polymerization reaction, a dimerization reaction, or the like (below, these are referred to jointly as “polymerizable material”).

The radiation polymerizable compound (hereinafter referred to as simply the “polymerizable compound”) used in the present invention is not limited to a particular compound, provided that the polymerizable compound is cured by producing a polymerization reaction due to application of energy of some kind, and it is possible to use monomer, oligomer or polymer species. However, it is particularly desirable to use a commonly known polymerizable monomer, such as a cationically polymerizable monomer or a radical polymerizable monomer, which generates a polymerization reaction by means of initiators generated from a polymerization initiator, which is added as desired.

It is also possible to use one or more of polymerizable compounds for the purpose of adjusting the reaction speed, the ink properties and the properties of the cured film, and the like.

### Cationically Polymerizable Compound

Possible examples of a cationically polymerizable compound usable as the polymerizable compound in the present invention are an epoxy compound, a vinyl ether compound, an oxetane compound, or the like, as described in Japanese Patent Application Publication No. 6-9714, Japanese Patent Application Publication No. 2001-31892, Japanese Patent Application Publication No. 2001-40068, Japanese Patent Application Publication No. 2001-55507, Japanese Patent Application Publication No. 2001-310938, Japanese Patent Application Publication No. 2001-310937, Japanese Patent Application Publication No. 2001-220526, and the like.

Possible examples of the epoxy compound are: an aromatic epoxide, an alicyclic epoxide, and the like.

As examples of a monofunctional epoxy compound usable in the present invention, it is possible to cite: phenyl glycidyl ether, p-tert-butyl phenyl glycidyl ether, butyl glycidyl ether, 2-ethyl hexyl glycidyl ether, allyl glycidyl ether, 1,2-butylene oxide, 1,3-butadiene monoxide, 1,2-epoxide decane, epichlorohydrin, 1,2-epoxydecane, styrene oxide, cyclohexane oxide, 3-methacryloyl oxymethyl cyclohexane oxide, 3-acryloyl oxymethyl cyclohexane oxide, 3-vinyl cyclohexene oxide, and the like.

As examples of a monofunctional vinyl ether usable in the present invention, it is possible to cite: methyl vinyl ether, ethyl vinyl ether, propyl vinyl ether, n-butyl vinyl ether, t-butyl vinyl ether, 2-ethyl hexyl vinyl ether, n-nonyl vinyl ether, lauryl vinyl ether, cyclohexyl vinyl ether, cyclohexyl methyl vinyl ether, 4-methyl cyclohexyl methyl vinyl ether, benzyl vinyl ether, dicyclopentenyl vinyl ether, 2-dicyclopentenoxy ethyl vinyl ether, methoxyethyl vinyl ether, ethoxyethyl vinyl ether, butoxyethyl vinyl ether, methoxyethoxy ethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethyl cyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, phenoxypolyethylene glycol vinyl ether, and the like.

The oxetane compound used in the present invention includes a compound containing an oxetane ring, and a commonly known oxetane compound, such as those described in Japanese Patent Application Publication No. 2001-220526, Japanese Patent Application Publication No. 2001-310937, Japanese Patent Application Publication No. 2003-341217, and the like, may be used.

Desirably, the compound having an oxetane ring which is contained in the ink composition used for carrying out the present invention is a compound having 1 to 4 oxetane rings in its structure. By using a compound of this kind, the viscosity of the ink composition can be maintained easily within a range that is suitable for handling, as well as obtaining good adhesiveness of the ink to the recording medium after curing.

As examples of a monofunctional oxetane compound usable in the present invention, it is possible to cite: 3-ethyl-3-hydroxymethyl oxetane, 3-(meta)allyloxymethyl-3-ethyloxetane, (3-ethyl-3-oxetanyl methoxy) methyl benzene, 4-fluoro-[1-(3-ethyl-3-oxetanyl methoxy) methyl] benzene, 4-methoxy-[1-(3-ethyl-3-oxetanyl methoxy) methyl] benzene, [1-(3-ethyl-3-oxetanyl methoxy) ethyl]phenyl ether, isobutoxymethyl (3-ethyl-3-oxetanyl methyl)ether, isobornyl oxyethyl (3-ethyl-3-oxetanyl methyl)ether, isobornyl (3-ethyl-3-oxetanyl methyl) ether, 2-ethyl hexyl (3-ethyl-3-oxetanyl methyl)ether, ethyl diethylene glycol (3-ethyl-3-oxetanyl methyl)ether, dicyclopentadiene (3-ethyl-3-oxetanyl methyl)ether, dicyclopentenyl oxyethyl (3-ethyl-3-oxetanyl methyl)ether, dicyclopentenyl (3-ethyl-3-oxetanyl methyl)ether, tetrahydro furfuryl (3-ethyl-3-oxetanyl methyl)ether, tetrabromophenyl (3-ethyl-3-oxetanyl methyl)ether, 2-tetrabromophenoxyethyl (3-ethyl-3-oxetanyl methyl)ether, tribromophenyl (3-ethyl-3-oxetanyl methyl)ether, 2-tribromophenoxyethyl (3-ethyl-3-oxetanyl methyl)ether, 2-hydroxyethyl (3-ethyl-3-oxetanyl methyl)ether, 2-hydroxypropyl (3-ethyl-3-oxetanyl methyl)ether, butoxyethyl (3-ethyl-3-oxetanyl methyl)ether, pentachlorophenyl (3-ethyl-3-oxetanyl methyl)ether, pentabromophenyl (3-ethyl-3-oxetanyl methyl)ether, bornyl (3-ethyl-3-oxetanyl methyl)ether, or the like.

For the compound having oxetane rings of this kind, it is suitable to use the compounds described in detail in paragraphs (0021) to (0084) of Japanese Patent Application Publication No. 2003-341217.

Of the oxetane compounds used in the present invention, it is desirable to use a compound having one to two oxetane rings from the viewpoint of the viscosity and the adhesiveness of the ink composition.

In the ink composition used for carrying out the present invention, it is possible to use only one type of these polymerizable compounds or two or more types of these polymerizable compounds.

### Radical Polymerizable Compound

Besides the compound having the radical polymerizable group and the cationically polymerizable group in the present invention, various commonly known radical polymerizable monomers which produce a polymerization reaction due to initiators generated from a photo-radical initiator can be used as a polymerizable compound in the present invention.

Examples of the radical polymerizable monomer usable in the present invention are: a (meth)acrylate, a (meth)acrylamide, an aromatic vinyl, or the like. In the present specification, the term “(meth)acrylate” indicates “acrylate” and/or “methacrylate”, and the term “(meth)acryl” indicates “acryl” and/or “methacryl”.

Examples of (meth)acrylates usable in the present invention include the following, for instance.

Examples of a mono functional (meth)acrylate are: a hexyl (meth)acrylate, 2-ethyl hexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butyl cyclohexyl (meth)acrylate, bornyl (meth)acrylate, isobornyl (meth)acrylate, benzyl (meth)acrylate, 2-ethylhexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy) ethyl (meth)acrylate, 2-(2-butoxyethoxy) ethyl (meth)acrylate, 2,2,2-tetrafluoroethyl (meth)acrylate, 1H,1H,2H,2H perfluorodecyl (meth)acrylate, 4-butyl phenyl (meth)acrylate, phenyl (meth)acrylate, 2,4,5-tetramethyl phenyl (meth)acrylate, 4-chlorophenyl (meth)acrylate, phenoxymethyl (meth)acrylate, phenoxyethyl (meth)acrylate, glycidyl (meth)acrylate, glycidyl oxybutyl (meth)acrylate, glycidyl oxyethyl (meth)acrylate, glycidyl oxypropyl (meth)acrylate, tetrahydrofurfuryl (meth)acrylate, hydroxyalkyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, 3-hydroxypropyl (meth)acrylate, dimethyl aminoethyl (meth)acrylate, diethyl aminoethyl (meth)acrylate, dimethyl aminopropyl (meth)acrylate, diethyl aminopropyl (meth)acrylate, trimethoxysilyl propyl (meth)acrylate, trimethylsilyl propyl (meth)acrylate, polyethylene oxide monomethyl ether (meth)acrylate, oligo-ethylene oxide monomethyl ether (meth)acrylate, polyethylene oxide (meth)acrylate, oligo-ethylene oxide (meth)acrylate, oligo-ethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligo-propylene oxide monoalkyl ether (meth)acrylate, 2-methacryloyloxy ethyl succinate, 2-methacryloyloxy hexahydro phthalate, 2-methacryloyloxy ethyl 2-hydroxypropyl phthalate, butoxy diethylene glycol (meth)acrylate, trifluoroethyl (meth)acrylate, perfluoro octylethyl (meth)acrylate, 2-hydroxy-3-phenoxy propyl (meth)acrylate, EO-modified phenol (meth)acrylate, EO-modified cresol (meth)acrylate, EO-modified nonyl phenol (meth)acrylate, PO-modified nonyl phenol (meth)acrylate, EO-modified 2-ethyl hexyl (meth)acrylate, and the like.

Examples of a (meth)acrylamide usable in the present invention include: (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxy methyl (meth)acrylamide, N-isopropyl (meth)acrylamide, N-methylol (meth)acrylamide, N,N-dimethyl (meth)acrylamide, N,N-diethyl (meth)acrylamide, or (meth)acryloyl morphine.

Specific examples of aromatic vinyls usable in the present invention are: styrene, methyl styrene, dimethyl styrene, trimethyl styrene, ethyl styrene, isopropyl styrene, chloromethyl styrene, methoxy styrene, acetoxy styrene, chlorostyrene, dichlorostyrene, bromostyrene, methyl ester of vinyl benzoic acid, 3-methyl styrene, 4-methyl styrene, 3-ethyl styrene, 4-ethyl styrene, 3-propyl styrene, 4-propyl styrene, 3-butyl styrene, 4-butyl styrene, 3-hexyl styrene, 4-hexyl styrene, 3-octyl styrene, 4-octyl styrene, 3-(2-ethyl hexyl) styrene, 4-(2-ethyl hexyl) styrene, allyl styrene, isopropenyl styrene, butenyl styrene, octenyl styrene, 4-t-butoxycarbonyl styrene, 4-methoxystyrene, or 4-t-butoxystyrene.

Examples of radical polymerizable monomers usable in the present invention include: vinyl esters (vinyl acetate, vinyl propionate, vinyl versatate, or the like), allyl esters (allyl acetate, or the like), a halogen-containing monomer (vinylidene chloride, vinyl chloride, or the like), a vinyl ether (methyl vinyl ether, butyl vinyl ether, hexyl vinyl ether, methoxy vinyl ether, 2-ethyl hexyl vinyl ether, methoxyethyl vinyl ether, cyclohexyl vinyl ether, chloroethyl vinyl ether, or the like), a vinyl cyanide ((meth)acrylonitrile, or the like), or an olefin (ethylene, propylene, or the like).

Of these, from the viewpoint of curing speed, it is desirable to use a (meth)acrylate or a (meth)acrylamide as the radical polymerizable monomer in the present invention.

It is possible either to use one type of polymerizable material only, or to use two or more types of polymerizable material.

The content of the polymerizable material in the ink, or if necessary, in the undercoat liquid, is desirably in the range of 50 wt % to 99.6 wt % with respect to the total solid content (weight) of the respective droplets, and more desirably, it is in the range of 70 wt % to 99.0 wt % and even more desirably, in the range of 80 wt % to 99.0 wt %, with respect to same.

Furthermore, desirably, the content of the polymerizable material in the droplets falls within the range of 20 wt % to 98 wt %, more desirably, the range of 40 wt % to 95 wt %, and especially desirably, the range of 50 wt % to 90 wt %, with respect to the total weight of the droplets.

### Polymerization Initiator

The ink in the present embodiment includes at least two types of polymerization initiators having different absorption wavelengths for the first curing and the second curing. Each polymerization initiator produces a substance such as a radical and an acid that initiates the chain reaction, for example, when the polymerization initiator is supplied with an active light, heat, or combination of these. The production of this substance results in the initiation and acceleration of polymerization of the above-described polymerizable compound, and the polymerizable compound is consequently cured.

It is desirable to include a polymerization initiator which generates the radical polymerization and the cationic polymerization as the polymerization mode, and it is especially desirable to include a photo-polymerization initiator.

A polymerization initiator may be a compound which generates at least one of a radical, an acid and/or a base, by producing a chemical change due to the action of light or mutual interaction with the electronically excited state of a sensitizing dye. Of these, a photo-activated radical generating agent or a photo-activated acid generating agent is desirable, from the viewpoint of enabling polymerization to be started by means of the simple device of exposure to light.

As a photo-polymerization initiator, it is possible to use a material selected appropriately to have sensitivity with respect to the radiated activating light rays, for example, ultraviolet light having the wavelength of 400 nm to 200 nm, far ultraviolet light, g rays, h rays, i rays, KrF excimer laser light, ArF excimer laser light, an electron beam, X rays, a molecular beam, an ion beam, or the like.

From the viewpoint of cost and safety, it is preferable to adopt a mode where the polymerizable compound of radical-polymerization type is cured by irradiation of an electron beam, since no initiator is required in this mode.

Any photo-polymerization initiator that is commonly known by a person skilled in the art may be used, without any particular restrictions, and many specific examples of photo-polymerization initiators are described, for example, in: Bruce M. Monroe, et. al., Chemical Review, 93, 435 (1993); R. S. Davidson, Journal of Photochemistry and Biology A: Chemistry, 73.81 (1993); J. P. Faussier, “Photoinitiated Polymerization-Theory and Applications”: Rapra Review, Vol. 9, Report, Rapra Technology (1998); and M. Tsunooka et al., Prog. Polym. Sci., 21.1 (1996). Furthermore, many chemically sensitized photoresists and compounds used in optical cationic polymerization are disclosed in “Organic Materials for Imaging,” (edited by Japanese Research Association for Organic Electronics Materials, published by Bunshin (1993), pp. 187 to 192). Moreover, also known are a group of compounds which produce oxidative or reductive bond cleavage due to interaction with the electronically excited state of a sensitizing dye, such as those described, for example, in F. D. Saeva, Topics in Current Chemistry, 156, 59 (1990), G. G. Maslak, Topics in Current Chemistry, 168, 1 (1993), H. B. Shuster, et al., JACS, 112, 6329 (1990), and I. D. F. Eaton, et al., JACS, 102, 3298 (1980).

Desirable examples of a photo-polymerization initiator are: (a) aromatic ketones; (b) aromatic onium salts; (c) organic peroxides; (d) hexaaryl diimidazole compounds; (e) ketoxime ester compounds; (f) borate compounds; (g) azinium compounds; (h) metallocene compounds; (i) activated ester compounds; (j) compounds having a carbon-halogen bond; and the like.

Desirable examples of the (a) aromatic ketones are, for example, compounds having a benzophenone skeleton or thioxanthone skeleton, such as those described in “Radiation Curing in Polymer Science and Technology,” J. P. Fouassier and J. F. Rabek (1993), pp. 77 to 117. As more desirable examples of the (a) aromatic ketones, it is possible to cite: an α-thiobenzophenone compound as described in Japanese Patent Publication No. 47-6416; a benzoin ether compound as described in Japanese Patent Publication No. 47-3981; an α-substituted benzoin compound as described in Japanese Patent Publication No. 47-22326; a benzoin derivative as described in Japanese Patent Publication No. 47-23664; an aroyl phosphonic acid ester as described in Japanese Patent Application Publication No. 57-30704; a dialkoxy benzophenone as described in Japanese Patent Publication No. 60-26483; a benzoin ether as described in Japanese Patent Publication No. 60-26403 and Japanese Patent Application Publication No. 62-81345; an α-aminobenzophenone as described in Japanese Patent Publication No. 1-34242, U.S. Pat. No. 4,318,791, and European Patent No. 0284561 A1; a p-di(dimethyl aminobenzoyl) benzene as described in Japanese Patent Application Publication No. 2-211452; a thio-substituted aromatic ketone as described in Japanese Patent Application Publication No. 61-194062; an acyl phosphine sulfide as described in Japanese Patent Publication No. 2-9597; an acyl phosphine as described in Japanese Patent Publication No. 2-9596; a thioxanthone as described in Japanese Patent Application No. 63-61950; a cumarine as described in Japanese Patent Application No. 59-42864; and the like.

The (b) aromatic omium salts include aromatic omium salts of elements of groups V, VI and VII of the periodic table, and more specifically, N, P, As, Sb, Bi, O, S, Se, Te or I. For example, it is suitable to use: an iodonium salt as described in European Patent No. 104143, the specification of U.S. Pat. No. 4,837,124, Japanese Patent Application Publication No. 2-150848, and Japanese Patent Application Publication No. 2-96514; a sulfonium salt as described in the respective specifications of European Patent No. 370693, European Patent No. 233567, European Patent No. 297443, European Patent No. 297442, European Patent No. 279210, European Patent No. 422570, U.S. Pat. No. 3,902,144, U.S. Pat. No. 4,933,377, U.S. Pat. No. 4,760,013, U.S. Pat. No. 4,734,444 and U.S. Pat. No. 2,833,827; a diazonium salt (such as a benzene diazonium which may contain a substituted group); a resin of a diazonium salt (such as a formaldehyde resin of diazo diphenylamine); an N-alkoxy pyridium salt (such as those described in the specification of U.S. Pat. No. 4,743,528, Japanese Patent Application Publication No. 63-138345, Japanese Patent Application Publication No. 63-142345, Japanese Patent Application Publication No. 63-142346 and Japanese Patent Publication No. 46-42363, and more specifically, 1-methoxy-4-phenyl pyridium tetrafluoroborate, for instance); or a compound such as those described in Japanese Patent Publication No. 52-147277, Japanese Patent Publication No. 52-14278 and Japanese Patent Publication No. 52-14279. These salts may generate radicals or acids as the active species.

The (c) “organic peroxides” described above include almost all organic compounds having one or more oxygen-oxygen body in the molecule, but desirable examples of same are peroxide esters, such as: 3,3′,4,4′-tetra-(t-butyl peroxycarbonyl) benzophenone, 3,3′,4,4′-tetra-(t-amyl peroxycarbonyl) benzophenone, 3,3′,4,4′-tetra-(t-hexyl peroxycarbonyl) benzophenone, 3,3′,4,4′-tetra-(t-octyl peroxycarbonyl) benzophenone, 3,3′,4,4′-tetra-(cumyl peroxycarbonyl) benzophenone, 3,3′,4,4′-tetra-(p-iso-propyl cumyl peroxycarbonyl) benzophenone, di-t-butyl di-peroxy isophthalate, and the like.

As examples of the (d) hexaaryl diimidazoles mentioned above, it is possible to cite a lophine dimer as described in Japanese Patent Publication No. 45-37377 and Japanese Patent Publication No. 44-86516, such as: 2,2′-bis(o-chlorophenyl)-4,4′,5,5′-tetraphenyl biimidazole; 2,2′-bis(o-bromophenyl)-4,4′,5,5′-tetraphenyl biimidazole; 2,2′-bis(o,p-dichloro-phenyl)-4,4′,5,5′-tetraphenyl biimidazole; 2,2′-bis(o-chlorophenyl)-4,4′,5,5′-tetra-(m-methoxyphenyl) biimidazole; 2,2′-bis(o,o′-dichloro-phenyl)-4,4′,5,5′-tetraphenyl biimidazole; 2,2′-bis(o-nitrophenyl)-4,4′,5,5′-tetraphenyl biimidazole; 2,2′-bis(o-methyl-phenyl)-4,4′,5,5′-tetraphenyl biimidazole; and 2,2′-bis(o-trifluoro-phenyl)-4,4′,5,5′-tetraphenyl biimidazole, and the like.

As examples of the (e) ketoxium esters mentioned above, it is possible to cite, for example, 3-benzoyloxy-iminobutane-2-one, 3-acetoxy-iminobutane-2-one, 3-propionyloxy-iminobutane-2-one, 2-acetoxy-iminopentane-3-one, 2-acetoxyimino-1-phenylpropane-1-one, 2-benzoyloxyimino-1-phenylpropane-1-one, 3-p-toluene sulfonyloxy iminobutane-2-one, and 2-ethoxycarbonyl oxyimino-1-phenylpropane-1-one, and the like.

Possible examples of the (f) borate compounds mentioned above are the compounds described in U.S. Pat. No. 3,567,453, U.S. Pat. No. 4,343,891, European Patent No. 109772 and European Patent No. 109773.

As examples of the (g) azinium compounds mentioned above, it is possible to cite a group of compounds having N—O bonds as described in Japanese Patent Application Publication No. 63-138345, Japanese Patent Application Publication No. 63-142345, Japanese Patent Application Publication No. 63-142346, Japanese Patent Application Publication No. 63-143537, and Japanese Patent Publication No. 46-42363.

As examples of the (h) metallocene compounds described above, it is possible to cite a titanocene compound as described in Japanese Patent Application Publication No. 59-152396, Japanese Patent Application Publication No. 61-151197, Japanese Patent Application Publication No. 63-41484, Japanese Patent Application Publication No. 2-249, or Japanese Patent Application Publication No. 2-4705, or an iron-arene complex as described in Japanese Patent Application Publication No. 1-304453 or Japanese Patent Application Publication No. 1-152109.

Specific examples of the aforementioned titanocene compound are: di-cyclopentadienyl-Ti-di-chloride; di-cyclopentadienyl-Ti-bis-phenyl; di-cyclopentadienyl-Ti-bis-2,3,4,5,6-pentafluorophen-1-yl; di-cyclopentadienyl-Ti-bis-2,3,5,6 tetrafluorophen-1-yl; di-cyclopentadienyl-Ti-bis-2,4,6-trifluorophen-1-yl; di-cyclopentadienyl-Ti-bis-2,6-di-fluorophen-1-yl; di-cyclopentadienyl-Ti-bis-2,4-di-fluorophen-1-yl; di-methyl-cyclopentadienyl-Ti-bis-2,3,4,5,6-pentafluorophen-1-yl; di-methyl-cyclopentadienyl-Ti-bis-2,3,5,6-tetrafluorophen-1-yl; di-methyl-cyclopentadienyl-Ti-bis-2,4-difluorophen-1-yl; bis(cyclopentadienyl)-bis(2,6-difluoro-3-(pyr-1-yl) phenyl) titanium; bis(cyclopentadienyl) bis[2,6-difluoro-3-(methyl-sulfonamide) phenyl] titanium; and bis(cyclopentadienyl) bis[2,6-difluoro-3-(N-butyl biaroyl-amino) phenyl] titanium, and the like.

Examples of the (i) active ester compounds described above are: a nitrobenzyl ester compound as described in the specifications of European Patent No. 0290750, European Patent No. 046083, European Patent No. 156153, European Patent No. 271851 and European Patent No. 0388343, the specifications of U.S. Pat. No. 3,901,710 and U.S. Pat. No. 4,181,531, Japanese Patent Application Publication No. 60-198538, and Japanese Patent Application Publication No. 53-133022; an iminosulfonate compound as described in the specifications of European Patent No. 0199672, European Patent No. 84515, European Patent No. 199672, European Patent No. 044115, and European Patent No. 0101122, the specifications of U.S. Pat. No. 4,618,564, U.S. Pat. No. 4,371,605, and U.S. Pat. No. 4,431,774, Japanese Patent Application Publication No. 64-18143, Japanese Patent Application Publication No. 2-245756, and Japanese Patent Application Publication No. 4-365048; and a compound as described in Japanese Patent Publication No. 62-6223, Japanese Patent Publication No. 63-14340 and Japanese Patent Application Publication No. 59-174831.

Desirable examples of the (j) compounds containing an oxygen halogen bond mentioned above are, for instance: a compound as described by Wakabayashi, et al., in Bull. Chem. Soc. Japan, 42, 2924 (1969), a compound as described in the specification of GB Patent No. 1388492, a compound as described in Japanese Patent Application Publication No. 53-133428, a compound as described in the specification of German Patent No. 3337024, or the like. Furthermore, it is also possible to cite a compound described by F. C. Schaefer, et. al., in J. Org. Chem., 29, 1527 (1964), a compound described in Japanese Patent Application Publication No. 62-58241, a compound described in Japanese Patent Application Publication No. 5-281728, and the like. It is also possible to cite a compound described in German Patent No. 2641100, a compound described in German Patent No. 3333450, a group of compounds described in German Patent No. 3021590, or a group of compounds described in German Patent 3021599, or the like.

Desirable specific examples of the compounds expressed by (a) to (j) above include the following.

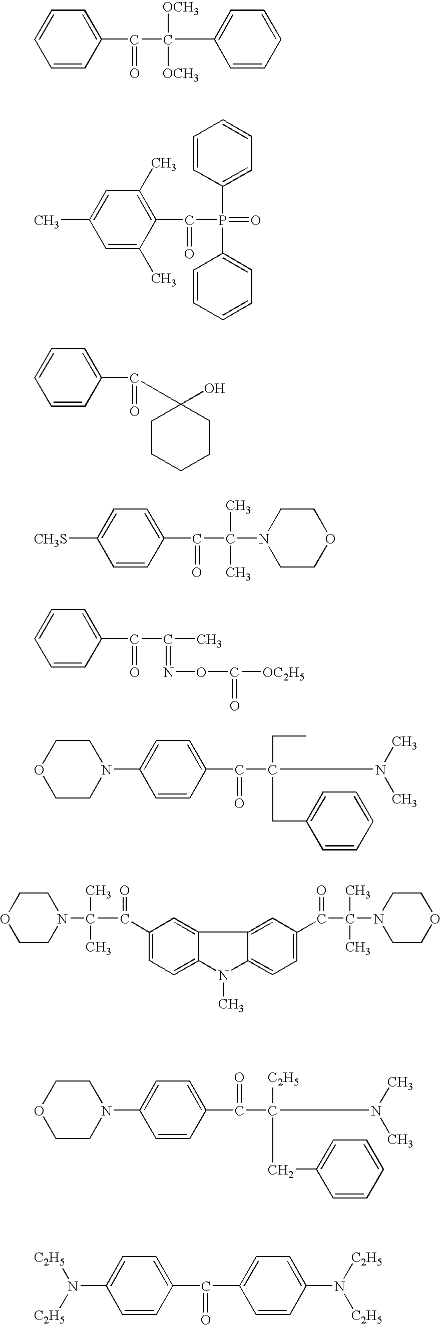

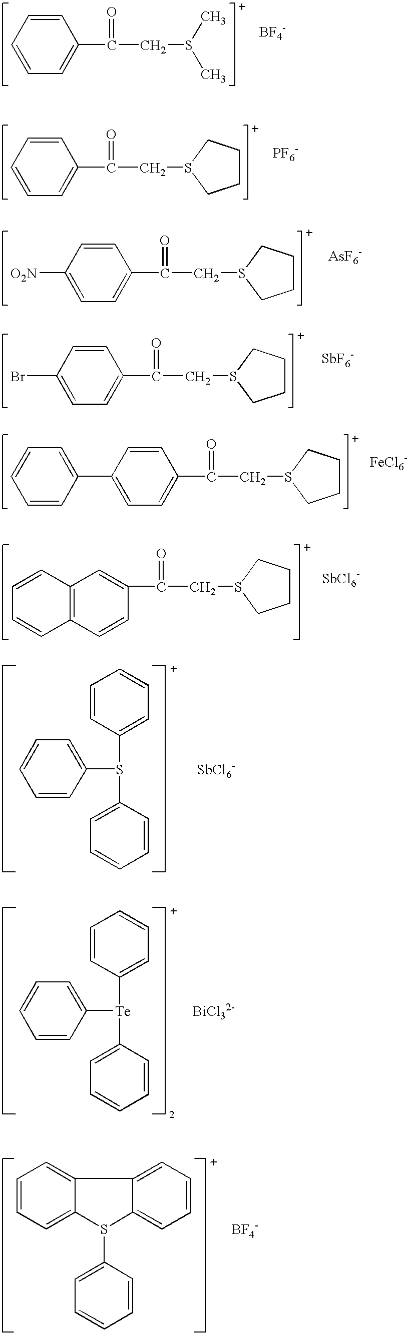

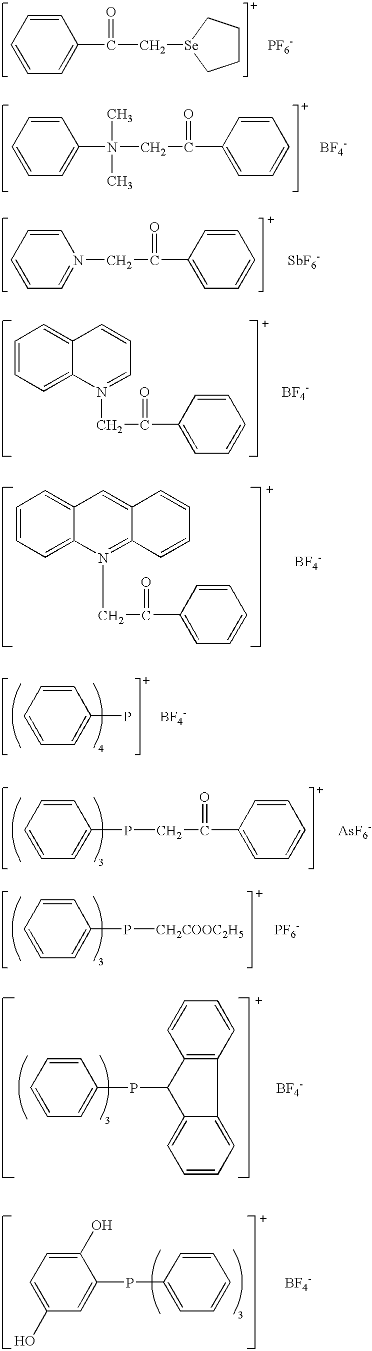

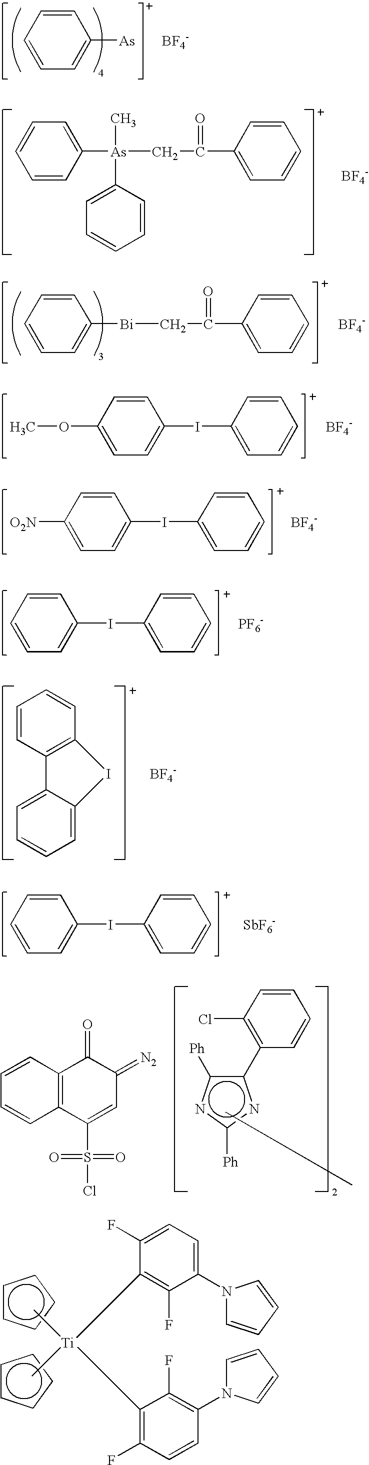

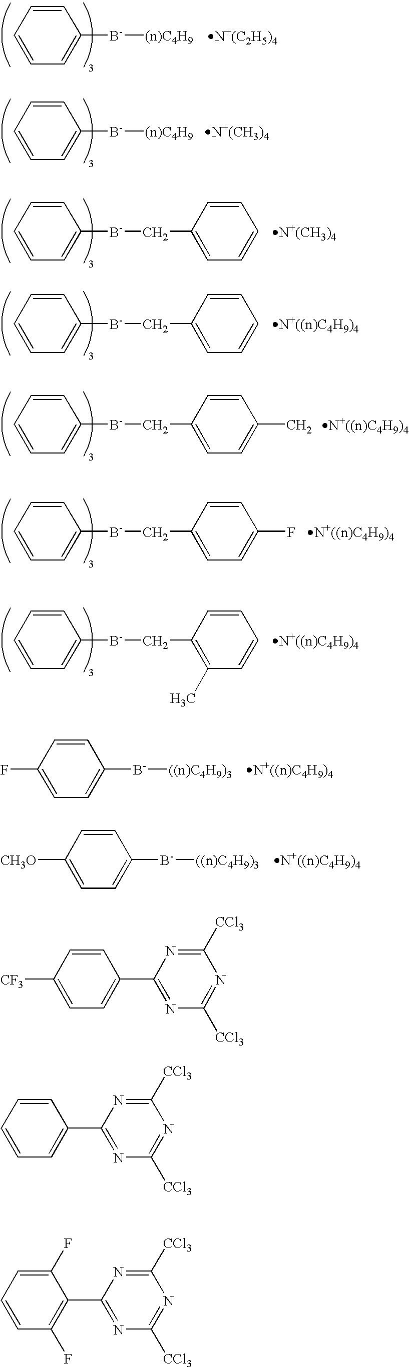

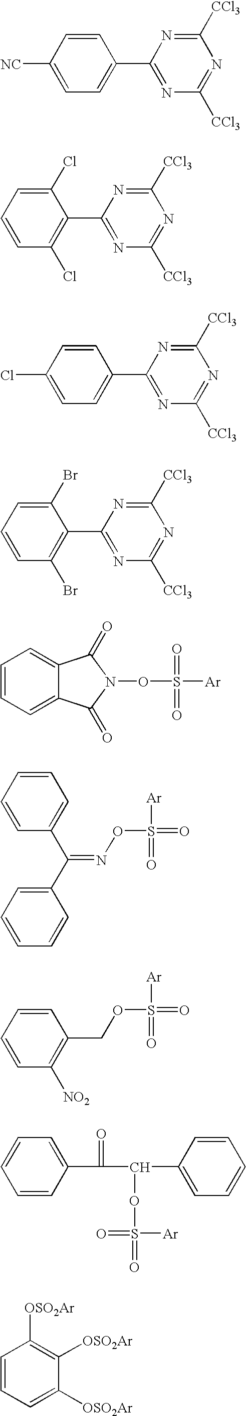

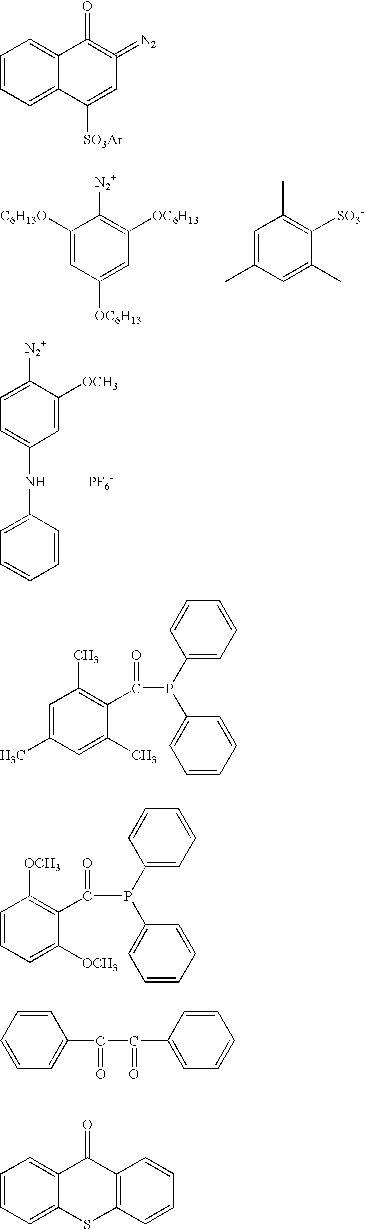

Desirably, the polymerization initiator has excellent sensitivity. Moreover, from the viewpoint of storage stability, it is not desirable to use a polymerization initiator which produces pyrolysis at a temperature of 80° C. or below, and therefore, preferably, a polymerization initiator which does not produce pyrolysis at temperatures up to 80° C. is chosen.

Provided that the beneficial effects of the present invention are not impaired, it is also possible to use a commonly known sensitizing agent, conjointly, with the object of improving sensitivity.

### Sensitizing Dye

Provided that the beneficial effects of the present invention are not impaired, it is also possible to add a sensitizing dye in the ink with the object of improving the sensitivity of the photo-polymerization initiator. As a desirable example of a sensitizing dye, it is possible to cite a dye belonging to the following group of compounds, which has an absorption wavelength in the range of 350 nm to 450 nm.

Desirable examples of a sensitizing dye are: polynuclear aromatic compounds (such as pyrene, perylene and triphenylene); xanthenes (such as fluorescein, cosine, erythrosine, rhodamine B and rose bengale); cyanines (such as thia-carbo cyanine and oxa-carbo cyanine); merocyanines (such as merocyanine and carbo merocyanine); thiazines (such as thionine, methylene blue and toluidine blue); acridine dyes (such as acridine orange, chloroflavin and acriflavine); anthraquinones (such as anthraquinone); squaliums (such as squalium); and coumarins (such as 7-diethylamino-4-methyl coumarin).

Examples of the sensitizing dye are the compounds represented by the following general formulas (IX) to (XIII) below.

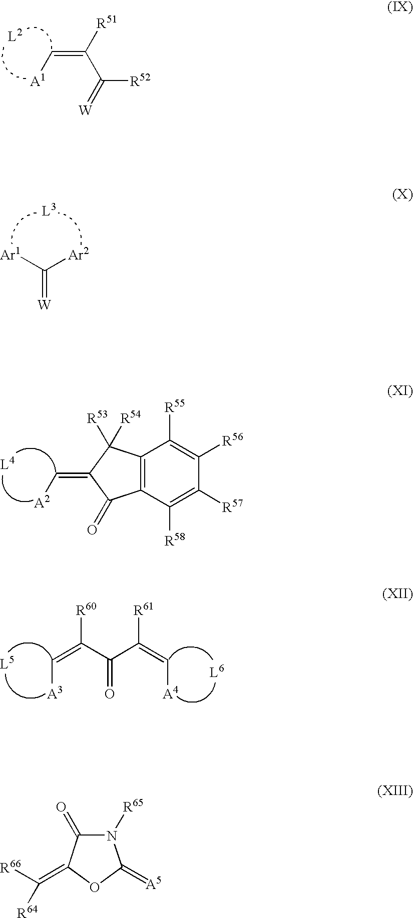

In Formula (IX), A¹ represents a sulfur atom or NR⁵⁰; R⁵⁰ represents an alkyl group or an aryl group; L² represents a non-metallic atomic group that forms a basic nucleus of the coloring material in conjunction with an adjacent A¹ and adjacent carbon atoms; R⁵¹ and R⁵² each represent a hydrogen atom or a monovalent non-metallic atomic group; and R⁵¹ and R⁵² may be linked to each other to form an acid nucleus of the coloring material. W represents an oxygen atom or a sulfur atom.

In Formula (X), Ar¹ and Ar² each represent an aryl group, and they are linked together by means of L³. Here, L³ represents —O— or —S—. Furthermore, W has the same meaning as that specified in general formula (IX).

In Formula (IX), A² represents a sulfur atom or NR⁵⁹, L⁴ represents a non-metallic atomic group that forms a basic nucleus of the coloring material in conjunction with an adjacent A² and carbon atoms; R⁵³, R⁵⁴, R⁵⁵, R⁵⁶, R⁵⁷ and R⁵⁸ each represent a monovalent non-metallic atomic group; and R⁵⁹ represents an alkyl group or an aryl group.

In Formula (XII), A³ and A⁴ each represent —S— or —NR⁶²— or —NR⁶³—; R⁶² and R⁶³ each represent a substituted or non-substituted alkyl group, and a substituted or non-substituted aryl group; L⁵ and L⁶ each represent a non-metallic atomic group that forms a basic nucleus of the coloring material in conjunction with the adjacent A³ and A⁴ and adjacent carbon atoms; and R⁶⁰ and R⁶¹ each represent a hydrogen atom or a monovalent non-metallic atomic group, or they may be linked together in order to form an aliphatic or aromatic ring.

In Formula (XIII), R⁶⁶ represents an aromatic ring or a hetero ring which may have a substituted group, and A⁵ represents an oxygen atom, a sulfur atom or —NR⁶⁷— R⁶⁴, R⁶⁵ and R⁶⁷ each represent a hydrogen atom or a monovalent non-metallic atomic group; R⁶⁷ and R⁶⁴, and R⁶⁵ and R⁶⁷ may be linked with each together to form an aliphatic or aromatic ring.

Desirable specific examples of compounds represented by the general formulas (IX) to (XIII) below include the example compounds (A-1) to (A-20) listed below.

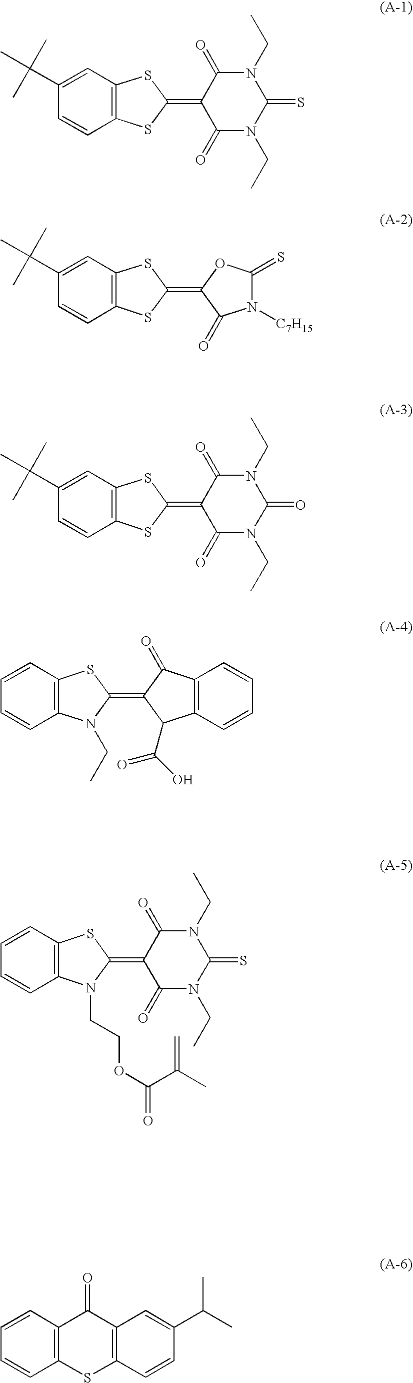

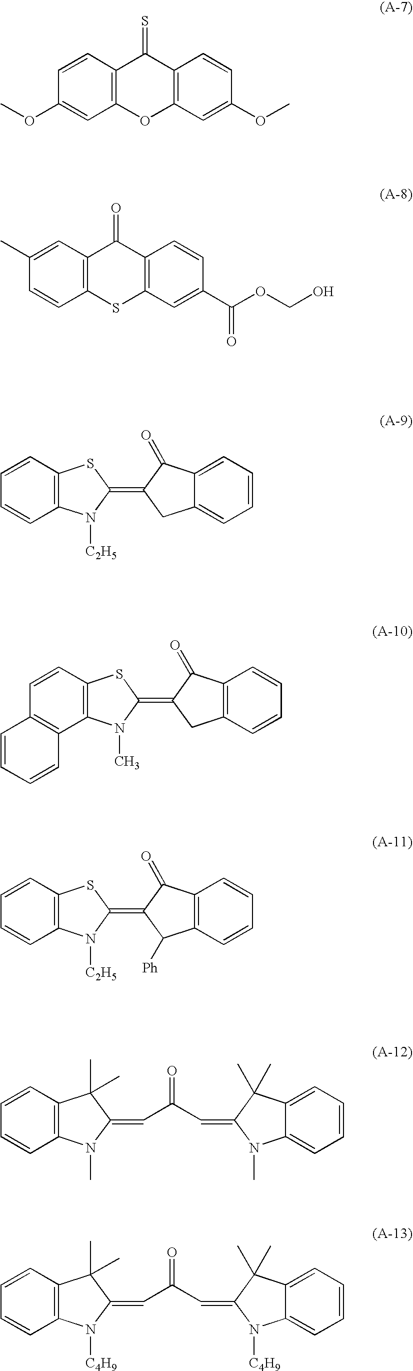

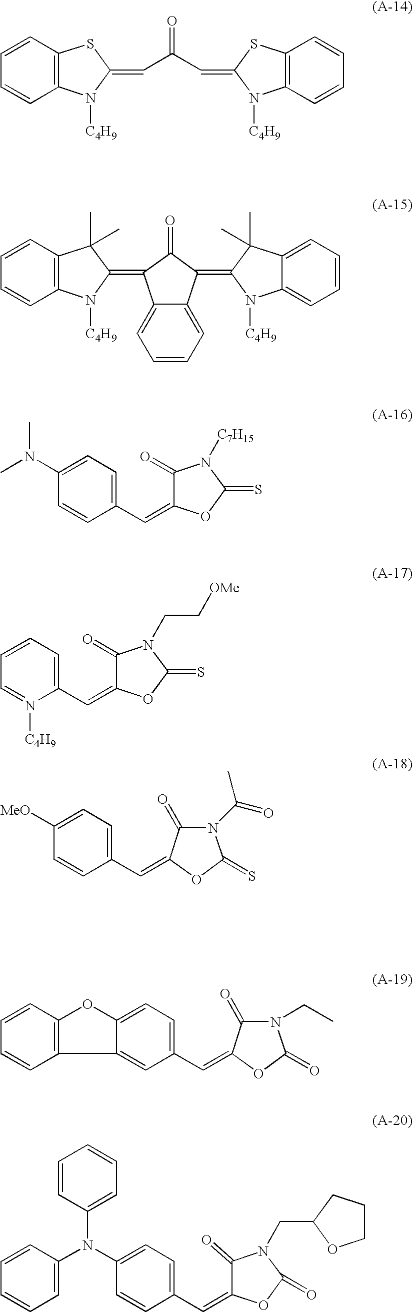

### Co-Sensitizing Agent

Moreover, it is also possible to add a co-sensitizing agent, which is a commonly known compound having the action of further enhancing sensitivity or suppressing inhibition of the polymerization reaction by oxygen.

Examples of a co-sensitizing agent include amines, such as the compounds described, for example, in M. R. Sander et. al., “Journal of Polymer Society”, Vol. 10, p. 3173 (1972), Japanese Patent Publication No. 44-20189, Japanese Patent Application Publication No. 51-82102, Japanese Patent Application Publication No. 52-134692, Japanese Patent Application Publication No. 59-138205, Japanese Patent Application Publication No. 60-84305, Japanese Patent Application Publication No. 62-18537, Japanese Patent Application Publication No. 64-33104, Research Disclosure No. 33825, and the like, and more specific examples of same are: triethanol amine, p-dimethyl amino benzoate ethyl ester, p-formyl dimethyl aniline, p-methylthio dimethyl aniline, and the like.

Other examples include thiols and sulfides, for example, a thiol compound as described in Japanese Patent Application Publication No. 53-702, Japanese Patent Publication No. 55-500806, or Japanese Patent Application Publication No. 5-142772, or a disulfide compound as described in Japanese Patent Application Publication No. 56-75643, and more specific examples are: 2-mercaptobenzothiazole, 2-meracptobenzoxazole, 2-mercaptobenzoimidazole, 2-mercapto-4(3H)-quinazoline, β-mercapto-naphthalene, and the like.

Other possible examples include amino acid compounds (for example, N-phenyl glycine), an organic metallic compound as described in Japanese Patent Publication No. 48-42965 (for example, tributyl tin acetate), a hydrogen donor as described in Japanese Patent Publication No. 55-34414, a sulfur compound as described in Japanese Patent Application Publication No. 6-308727 (for example, trithiane), a phosphorus compound as described in Japanese Patent Application Publication No. 6-250387 (diethyl phosphite, or the like), or an Si—H or Ge—H compound, or the like, as described in Japanese Patent Application Publication No. 8-65779.

The coloring material used in the ink may include either a dye or a pigment, or it may include both of a dye and a pigment.

There are no particular restrictions on the pigment used in the present invention, but specific examples of an orange or yellow pigment include: C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 128, C. I. Pigment Yellow 138, C. I. Pigment Yellow 151, C. I. Pigment Yellow 155, C. I. Pigment Yellow 180, C.I. Pigment Yellow 185, or the like.

Specific examples of a red or magenta pigment include: C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, C.I. Pigment Red 222, or the like.

Specific examples of a green or cyan pigment include: C. I. Pigment Blue 15, C. I. Pigment Blue 15:2, C. I. Pigment Blue 15:3, C. I. Pigment Blue 16, C. I. Pigment Blue 60, C.I. Pigment Green 7, or the like.

Specific examples of a black pigment include: C. I. Pigment Black 1, C. I. Pigment Black 6, C.I. Pigment Black 7, or the like.

The concentration of the coloring material contained in the ink used in the present embodiment is set to an optimum value in accordance with the coloring material used, but desirably, it is set to a range of 0.1 wt % to 40 wt % with respect to the total weight of ink. More desirably, the concentration range is 1 wt % to 30 wt %, and even more desirably, it is 2 wt % to 20 wt %.

Desirably, the viscosity of the ink used in the present embodiment is 1.0 cP to 20.0 cP.

Apart from the foregoing, according to requirements, it is also possible to add a pH buffering agent, an anti-oxidation agent, an anti-rusting agent, a viscosity adjuster, a conductive agent, or the like.

It is possible to polymerize selectively one of the polymerizable groups (i.e., the radical polymerizable group and the cationically polymerizable compound) by selecting the combination of the radical generating agent (radical polymerization initiator) and the acid generating agent (cationic polymerization initiator) such that the absorption wavelengths are different from each other. In order to polymerize only one of the polymerizable groups selectively, it is suitable to use a light source having a narrow full width at half maximum (also referred to as “half-width”) for the light emission wavelength, such as a light emitting diode (LED) and a laser diode (LD; also referred to as “semiconductor laser”), and the like, as the light source for the initial curing (first curing) on the intermediate transfer body. For curing (second curing) on the recording medium it is not necessary to use a light source having a narrow light emission waveband, but rather a light source having a broad light emission waveband including the absorption wavelength of the initiator for the second curing, can be used. For example, it is possible to use a low-pressure mercury lamp, a high-pressure mercury lamp, or a metal halide lamp.

It is also suitable to carry out the second curing by using an electron beam. If curing by means of an electron beam is adopted, in addition to characteristic features including: the fact that the amount of unreacted polymerizable groups can be reduced; and that light absorption by the pigment is not affected and curing can therefore be made to reach into the interior of the ink film, it is also possible to utilize the fact that curing can be performed without using an initiator, and therefore to omit the polymerization initiator for the second curing. In this case, it is not necessary to use a light source having a narrow light emission waveband as the light source for the first curing, and it is possible to use an inexpensive UV light source having a broad light emission waveband (for example, a low-pressure mercury lamp, a high-pressure mercury lamp, a metal halide lamp, or a fluorescent lamp).

A possible specific combination is, for example, one where an LED is used as the light source for the first curing, a compound having an absorption peak in the vicinity of the light emission wavelength of the LED is selected as the initiator for the first curing, and a compound having an absorption peak at a shorter wavelength than the absorption peak wavelength of the initiator for the first curing and having virtually no absorption at the peak light emission wavelength of the LED (i.e., light source for the first curing) is selected as the initiator for the second curing. As stated above, the light emission spectrum of the light source for the second curing may be broad, provided that it includes the absorption wavelength of the polymerization initiator for the second curing.

One example of a group of polymerization initiators having different absorption wavelengths is a combination of: bis(2,4,6-trimethyl benzoyl)-phenyl phosphine oxide (product name: IRGACURE 819 manufactured by Ciba Specialty Chemicals Inc.) having absorption peak wavelengths of 295 nm and 370 nm, as the polymerization initiator (photo-activated radical generating agent) for the first curing; an ultraviolet LED having a peak light emission wavelength of 365 nm (NSHU 550B manufactured by Nichia Corporation), as the light source for the first curing; indonium, (4-methyl phenyl)[4-(2-methyl propyl) phenyl]-hexafluorophosphate (product name: IRGACURE 250 manufactured by Ciba Specialty Chemicals Inc.) which has an absorption peak wavelength at 240 nm and shows virtually no absorption at 340 nm or above, as the polymerization initiator (photo-activated acid generating agent) for the second curing; and a high-pressure mercury lamp, having light emission peaks at 365 nm, 313 nm and 254 nm (for example, UM-452 manufactured by Ushio Inc.), as the light source for the second curing. FIG. 6 is a diagram showing the above-described combination of the polymerization initiators having different absorption wavelengths and the light sources.

In cases where the second curing is carried out by means of the electron beam, a combination is also possible in which the first curing is carried out by means of a metal halide lamp (for example, Vzero manufactured by Integration Technology) having a relatively broad light emission spectrum as the light source for the first curing, and the second curing is carried out by means of a low-energy electron beam irradiation apparatus (for example, a Min-EB irradiation tube manufactured by Ushio Inc.).

Desirably, the radical polymerization is carried out in the first curing, and the cationic polymerization is carried out in the second curing. In the first curing, it is necessary that the curing is completed on the intermediate transfer body, and in general, the radical polymerization reaction proceeds more rapidly than the cationic polymerization reaction and is therefore more suitable for the first curing. In the case of the second curing, it is desirable that the cross-linking reaction should proceed reliably, even if the reaction is slow. In the radical polymerization reaction, the polymerization reaction proceeds only while the radiation is being irradiated, and on the other hand, the cationic polymerization reaction is a living polymerization reaction in which polymerization continues due to the acid that has been produced, even after the irradiation is terminated. From this viewpoint, since the cross-linking of the second curing continues in a dark reaction, then even if the light source for the second curing has a low illuminance, a satisfactory cross-linking reaction is ultimately achieved and a good ink film is formed. Since the second curing does not require the selectivity of curing (polymerization), then it is desirable to use a metal halide type of UV lamp which has a broad light emission waveband. The second curing may also be carried out by means of a thermal polymerization reaction, rather than radiation-induced polymerization. Furthermore, it is also possible to use a combination of photo-polymerization and thermal polymerization activated by heating.

In order to perform printings rapidly, a desirable composition is one in which the printing of one page is completed in a single scan, by using a full line type of droplet ejection head having a nozzle row corresponding to the width of the full recordable region on the recording medium (in other words, the page width). However, when the full line type of ejection head is used, in contrast to a shuttle scanning method which carries out split printing, the ink cannot be cured in each scanning action, and it is therefore difficult to achieve high image quality unless the coalescence of ink droplets deposited on mutually adjacent positions is prevented.

As an effective means of preventing the interference (e.g., coalescence of the adjacently deposited ink droplets; hereinafter, referred to as “depositing interference”) between ink droplets on the intermediate transfer body, it is desirable to apply an uncured undercoat liquid containing a radiation polymerizable compound on the intermediate transfer body. Droplets of radiation polymerizable ink are deposited on the region where this undercoat layer is present in the form of a liquid film on the intermediate transfer body. In so doing, by setting the relationship between the dynamic surface tension value γ1 (0.1 s) of the undercoat layer at a surface age of 0.1 seconds, and the dynamic surface tension value γ2 (0.1 s) of the ink at a surface age of 0.1 seconds to be such that γ1 (0.1 s)<γ2 (0.1 s), the deposited droplets of ink sink into the undercoat liquid (i.e., the ink droplets deposited on the undercoat liquid move into the interior of the undercoat liquid), and therefore the coalescence between the ink droplets can be prevented.

The undercoat liquid contains substantially no coloring material, and if it does contain coloring material, this content of the coloring material is less than 1 wt %. It is desirable to add a surfactant to the undercoat liquid, in order to reduce the surface tension.

The dynamic surface tension is a value that is measured with a bubble pressure method.

Desirably, the mol ratio of the group (i.e., first group) that is cured in the first curing with respect to the total of the first group and the group (i.e., second group) that is cured in the second curing is 60% through 90%. If the ratio of the first group is too high, then the cross-linking density in the ink film ultimately formed on the recording medium will decline, and therefore the film strength on the recording medium becomes insufficient. On the other hand, if the ratio of the first group is too low, then there is a tendency for the curing sensitivity on the intermediate transfer body to decline.

In order that the material cured in the first curing is transferable, then it is necessary for the first cured matter on the intermediate transfer body to have thermoplastic properties. Therefore, it is necessary for one first group to be present in each molecule, in other words, that the ratio of monofunctional polymerizable compound should be high.

In the present embodiment, the cured matter produced by the first curing on the intermediate transfer body shows thermoplastic properties. The temperature during transfer is required to be not lower than the softening point after the first curing, and not higher than a temperature above the softening point by 10° C., and desirably, it is not higher than a temperature above the softening point by 3° C. In this temperature region, the ink on the intermediate transfer body assumes properties which are suitable for transfer. If the transfer temperature is too low, then the adhesion of the ink to the recording media deteriorates and the transfer rate declines, and if on the other hand, the transfer temperature is too high, then the ink on the intermediate transfer body assumes a liquid state and remains on the intermediate transfer body, as well as giving rise to the bleeding on the permeable media, thus causing degradation of the image quality.

### [Method of Measuring Softening Point]

The softening point of the ink cured by the first curing on the intermediate transfer body can be measured by means of a Vicat softening point measurement apparatus or a similar thermo-mechanical analyzer (TMA). However, in normal Vicat softening point measurement, a probe of 1 mm diameter is used at a load of 1 kg and the temperature at the time that the probe has been introduced 1 mm is measured, but when measuring the softening point of a thin film, as in the present embodiment, it is suitable to use a thermo-mechanical analyzer (TMA), and to measure with a narrow-diameter probe, at a light load, and to a small insertion depth. More specifically, using a probe of 0.5 mm diameter and a load of 500 mN, the insertion depth of the probe is measured while the temperature is raised, and the softening point is defined as the temperature at which there is a sudden increased in the insertion depth.

### Second Embodiment

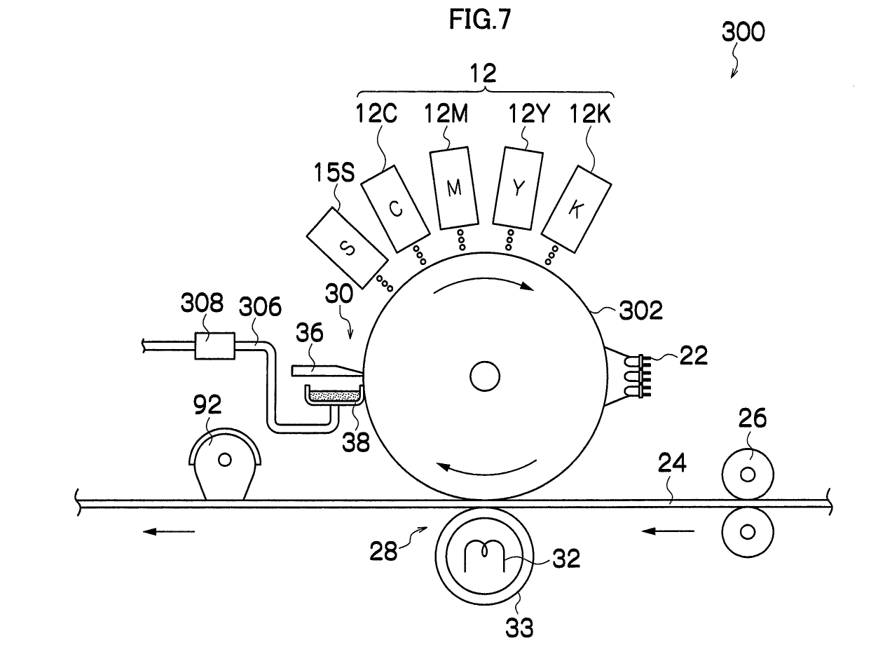

Next, a second embodiment of the present invention is described. FIG. 7 is a general schematic drawing of an inkjet recording apparatus 300 according to the second embodiment of the present invention. Items which are the same as or similar to those in the first embodiment described above are labeled with the same or similar reference numerals and description thereof is omitted here.

As shown in FIG. 7, an intermediate transfer body 302 has a round cylindrical shape. In a mode where a drum-shaped member of this kind is used for the intermediate transfer body 302, a beneficial effect is obtained in that the throw distance (namely, the distance between the nozzle forming surfaces of the heads 12C, 12M, 12Y and 12K, and the intermediate transfer body 16) is stable. In a mode, on the other hand, where an intermediate transfer body 16 formed by a belt-shaped member as shown in FIG. 1 is used, it is possible to dispose the heads of a plurality of colors 12C, 12M, 12Y and 12K in a horizontal fashion, and therefore the arrangement structure of the heads is simplified.

Furthermore, in the mode shown in FIG. 7, the second radiation source 92 is also provided which fully fixes the image that has been transferred, on the recording medium 24. The second radiation source 92 used may have the same specifications as the first radiation source 22 used to provisionally solidify the ink droplets deposited on the intermediate transfer body 302, but the applied energy required in order to fully fix the image on the recording medium 24 is greater than the applied energy used in provisionally solidifying the image on the intermediate transfer body 302, and therefore it is desirable that the second radiation source 92 has a greater energy application capacity than the first radiation source 22.

Moreover, in the mode shown in FIG. 7, a flow channel 306 which connects to a recovery unit 38 where the residual ink removed from the intermediate transfer body 302 is recovered, and a recycling unit 308 for recycling the residual ink, are provided. By recycling the residual ink in this way, it is possible to reuse the ultraviolet-curable polymerizable compound, which is highly expensive, thereby contributing to reducing the running costs of the inkjet recording apparatus 300.

In the mode shown in FIG. 1 also, a desirable mode is one which includes the recycle processing unit 308 shown in FIG. 7 for recycling residual ink.

### Third Embodiment

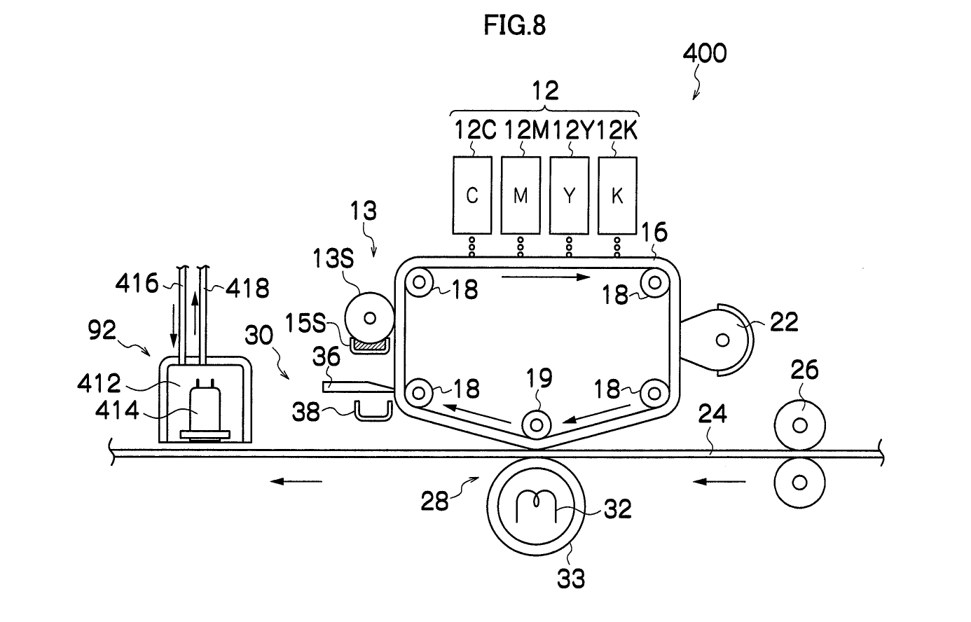

Next, a third embodiment of the present invention is described. FIG. 8 is a general schematic drawing of an inkjet recording apparatus 400 according to a third embodiment. In FIG. 8, items which are the same as or similar to those of the composition shown in FIGS. 1 and 7 are denoted with the same reference numerals and description thereof is omitted here.

The inkjet recording apparatus 400 shown in FIG. 8 is an intermediate transfer type of apparatus that uses an electron beam curable ink containing a polymerizable compound that is cured by polymerization when irradiated with an electron beam, and the inkjet recording apparatus 400 includes an electron beam irradiation device as the second radiation source 92, which fixes the ink on the recording medium 24 by curing the ink by polymerization.

The electron beam irradiation device has a structure in which an electron beam generating source 414 is disposed inside a chamber (irradiation chamber) 412 into which nitrogen gas (N2) is introduced, and an electron beam is radiated onto the recording medium 24 through an irradiation window 420 opposing the recording medium 24. The reference numeral 416 denotes a gas supply channel for introducing nitrogen gas, and the reference numeral 418 denotes an exhaust channel. It is possible to use a device in which nine tubes of Min-EB (manufactured by Ushio Inc.) are arranged, as the electron beam irradiation device.

According to the third embodiment, the above-described beneficial effects can be obtained even if an ink and an undercoat liquid which contain no cationically polymerizable initiator are used.

### EXAMPLES

Next, the present invention is described in more detail with reference to practical examples, but the present invention is not limited to these practical examples.

### Practical Example 1

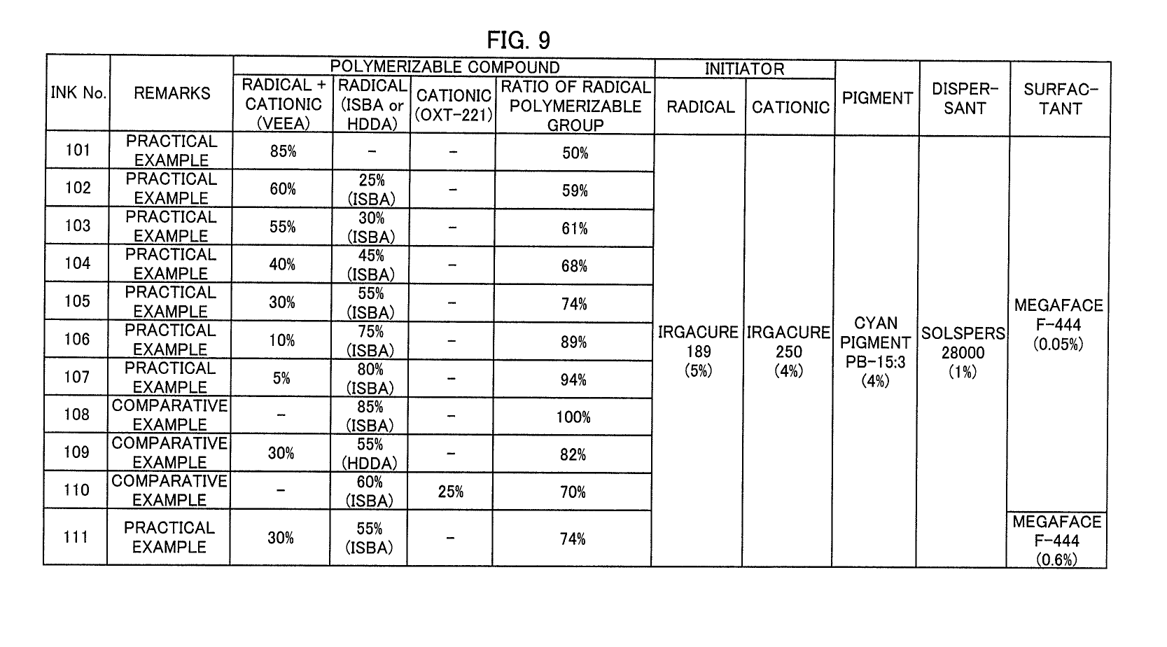

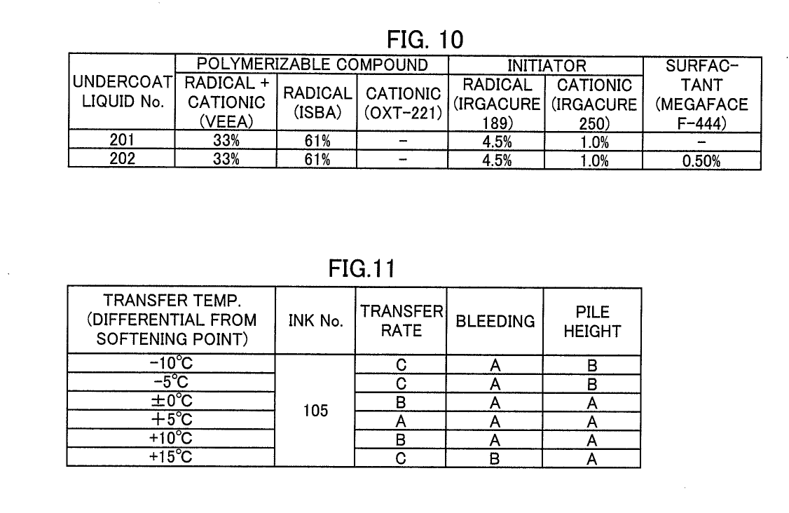

FIG. 9 is a diagram showing the compositions of inks 101 to 111 used in the practical examples; and FIG. 10 is a diagram showing the compositions of undercoat liquids 201 and 202 used in the practical examples.

The ink 101 to 111 and the undercoat liquids 201 and 202 having the compositions shown in FIGS. 9 and 10 were prepared by dispersion in a bead mill using zirconia beads. All of the prepared liquids were filtered through a 5-μm diameter filter.

The abbreviations used in FIGS. 9 and 10 are as follows. “VEEA” represents 2-(2-hydroxyethoxy) ethyl acrylate manufactured by Nippon Shokubai Co., Ltd.; “ISBA” represents isobornyl acrylate manufactured by Shin-Nakamura Chemical Corporation; “HDDA” represents 1,6-hexane diol diacrylate manufactured by Shin-Nakamura Chemical Corporation; “OXT-221” represents bis(3-ethyl-3-oxetanyl methyl)ether manufactured by Toagosei Co., Ltd.; “Irgacure 189” represents radical polymerization initiator manufactured by Ciba Specialty Chemicals; “Irgacure 250” represents cationic polymerization initiator manufactured by Ciba Specialty Chemicals Inc.; “Solspers 28000” represents dispersant manufactured by Avecia Ltd.; “Megaface F-444” represents fluorine-based surfactant manufactured by Dai-Nippon Ink Inc.; and “Cyan pigment PB 15:3” represents Irgalite Blue GLVO manufactured by Ciba Specialty Chemicals Inc.

As shown in FIG. 9, the polymerizable compounds contained in the inks 101 to 111 includes: a polymerizable compound (i.e, VEEA) having a molecular structure including a radical polymerizable group and a cationically polymerizable group; a polymerizable compound (i.e., ISBA) having a molecular structure including a radical polymerizable group (mono-functional group), only; a polymerizable compound (i.e., HDDA) having a molecular structure including a radical polymerizable group (bi-functional group), only; and a polymerizable compound (i.e., OXT-221) having a molecular structure including a cationically polymerizable group, only.

The viscosity of the inks 101 to 111 at 45° C. was 10 mPa·s to 15 mPa·s, and the surface tension at 25° C. was in the range of 24 mN/m to 35 mN/m.

### <Measurement of Softening Point>

Specifically, the softening point is defined as the temperature at which there is a sudden increase in the probe insertion depth, when the probe insertion depth is measured while raising the temperature, using a probe diameter of 0.5 mm and a load of 500 mN, and in order to measure the softening point, sample pieces were prepared by bar coating the respective the inks 101 to 111 to a thickness of 0.5 mm on a stainless steel plate, and then radiating UV light using an ultraviolet LED having a light emission peak wavelength of 365 nm (NSHU 550B manufactured by Nichia Corp.) as a curing light source, thereby forming cured films (i.e., sample pieces). For each of these sample pieces, the probe insertion depth was measured while raising the temperature, using a 0.5 mm probe at 500 mN load in a thermo-mechanical analyzer (TMA), following a method similar to JISK 7206, and the temperature at which there was a sudden increase in the insertion depth was taken to be the softening point.

The softening points of the cured inks apart from the ink 109 were in the range of 120° C. to 180° C. (for example, the cured ink 105 had a softening point of 136° C.), but the cured ink 109 did not soften in the range between 40° C. and 250° C. Incidentally, 250° C. is the ignition temperature of cotton or newspaper, and therefore a system which heats to a temperature equal to or greater than 250° C. is not practicable.

### <Transfer Temperature Dependence>

The prepared ink 105 (practical example) was loaded into an inkjet recording apparatus 10 according to an embodiment of the present invention, and a test image including step-shaped patch images in which the droplet ejection density changes successively in 8 steps from 0% to 100% was recorded on high-grade paper (C2 paper made by Fuji Xerox Co., Ltd.) and the evaluations described below were carried out.

The temperature of the transfer heating roller 33 in the transfer unit 28 was changed in 5° C. steps in a range of −10° C. to +15° C. with respect to the softening point of the ink 105. The nip pressure was set to 1.2 MPa. In this evaluation, the temperature was determined by placing the recording medium (media) on top of the transfer heating roller 33 and then measuring the temperature on the medium by means of an infrared thermometer device. Although the temperature actually measured is that of the recording medium during transfer, in practice, it is the temperature of the transfer heating roller 33 that is being measured (indirectly).

The transfer rate is determined by comparing the ink transferred to the media after the transfer step with the ink density remaining on the intermediate transfer body, in a portion where droplets have been deposited at a rate of 50%.

A: No residue on intermediate transfer body; 100% transferred.

B: 90% or more transferred.

C: 80% or more transferred.

The ink dots transferred onto the media were observed with a microscope, and it was evaluated whether or not the ink had passed along the fibers of the paper and given rise to bleeding.

A: no bleeding observed.

B: bleeding along paper fibers observed.

In the evaluation of the pile height, after transfer, the media was placed on a horizontal bench and illuminated from above with a fluorescent lamp, and the printed region was observed obliquely from above at an angle of 30 degrees to make a perceptional evaluation of the protrusion of the printed region of ink (pile height). The criteria relating to the evaluation of pile height in FIG. 11 are as follows.

A: Pile height not noticeable.

B: Large pile height; protrusion creates unnatural appearance.

FIG. 11 is a diagram showing the results of the above evaluations. As shown in FIG. 11, it can be seen that when the transfer temperature is not lower than the softening point and not higher than a temperature above the softening point by 10° C., the transfer rate is satisfactory, no bleeding occurs, the transferred ink dots are pressed and crushed, and the pile height, which is liable to occur in a typical UV inkjet recording apparatus, is markedly improved. On the other hand, it can be seen that, if the transfer temperature is lower than the softening point, then the transfer rate declines, and the pile height also becomes problematic, whereas if the transfer temperature is +15° C. with respect to the softening point, then the ink viscosity falls too low on the intermediate transfer body, and therefore undesirable effects such as decline in the transfer rate and bleeding of the ink occur.

Next, the transfer characteristics and the strength of the ink film were compared in respect of the ink compositions. For each ink, the transfer temperature was set to +5° C. with respect to the softening point.

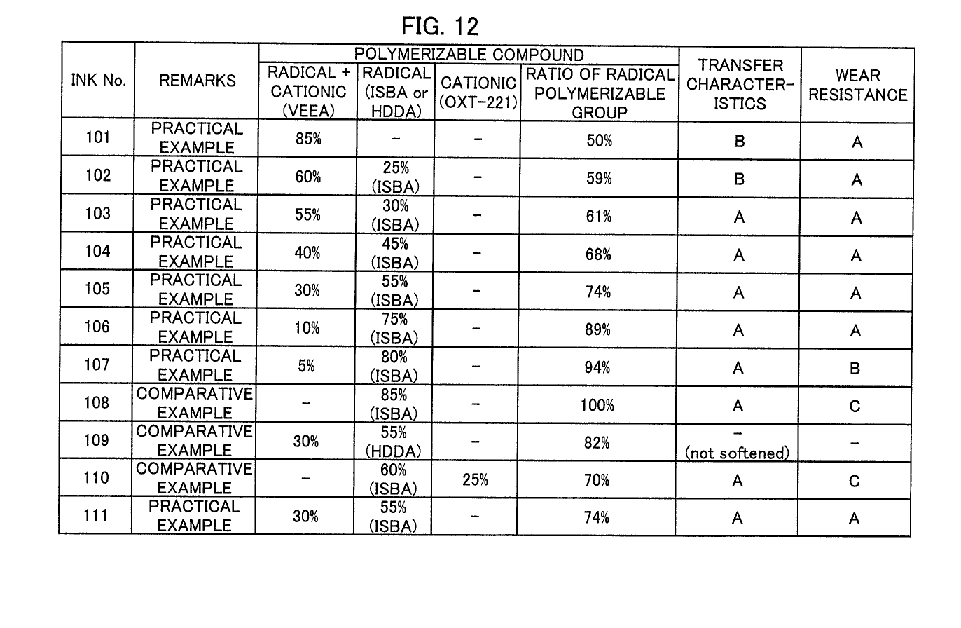

The wear characteristics were evaluated by pressing a solid portion which had been transferred onto the media, against a strip of the same media (high-grade paper) having a size of 2 cm×3 cm, rubbing 20 times while applying a force of 20 Kgf, and then observing the ink which has adhered to the strip of media from the solid portion. FIG. 12 is a diagram showing the results of this evaluation. The criteria for this evaluation are as follows.

A: absolutely no adherence of ink to media strip observed

B: slight adherence of ink to media strip observed

C: adherence of ink to media strip clearly observed

As shown in FIG. 12, the ink 109, which contained a bifunctional radical polymerizable compound, did not display thermoplastic properties (not softened) after the first curing, and could not be transferred, but for all of the other inks, the transfer characteristics were good. As shown in FIG. 12, it can be seen that the transfer rate is slightly lower when the ratio of the radical polymerizable group is equal to or less than 60%. It is thought that the transfer rate declines due to a slight degree of cross-linking which occurs in the first curing. Naturally, if the ratio of the cationically polymerizable group becomes lower, then the number of cross-links created in the second curing is reduced, and therefore the strength of the ink film declines. Consequently, it is desirable that the ratio of the radical polymerizable group should be not less than 60% and not greater than 90%. Furthermore, in the ink 110, in which the radical polymerizable compound (i.e., ISBA) and the cationically polymerizable compound (i.e., OXT-221) are simply mixed with each other, the strength of the ink film is not improved, even after the second curing. It can be seen that the beneficial effects of the present invention are displayed as a result of the polymers produced by the first curing being cross-linked by the second curing, due to the presence of a compound (e.g., VEEA) having a radical polymerizable group and a cationically polymerizable group in the each molecule.

### Practical Example 2 Beneficial Effects of Undercoat Liquid

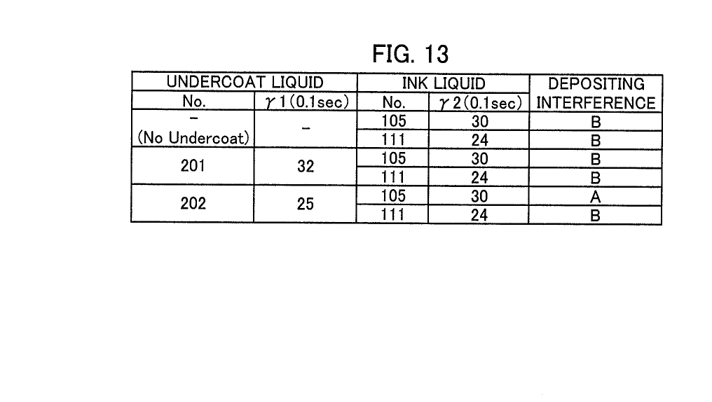

The inks 105 and 111 having different dynamic surface tensions (γ2 (0.1 s)) were ejected as droplets to form a lattice-shaped test image, on an intermediate transfer body, and were then transferred onto high-grade paper. The samples thus obtained were observed with a microscope, and the evaluation as to the depositing interference was carried out. FIG. 13 is a diagram showing the results of this evaluation. As shown in FIG. 13, when no undercoat liquid is applied on the intermediate transfer body, the depositing interference giving rise to disruption of the line widths was observed, due to the coalescence between mutually adjacent dots. On the other hand, when an undercoat liquid having a different dynamic surface tension (γ1 (0.1 s)) was applied by means of a roller coater onto the intermediate transfer body, to a thickness of 4 μm, and ink droplets were then deposited onto the undercoat liquid, an image of high quality which was free of the depositing interference was obtained only in cases where the dynamic surface tension of the undercoat liquid was lower than the dynamic surface tension of the ink liquid.

### Practical Example 3

Similar beneficial effects were obtained when an art paper (Tokubishi Art made by Mitsubishi Paper Mills) or PET sheet (OHP sheet made by Fuji Xerox) was used instead of the high-grade paper as the recording medium in Practical Examples 1 and 2. It is clear that the ink can be applied to a wide range of media, from permeable media to non-permeable media.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming method, comprising the steps of:
ejecting and depositing an ink containing a coloring material and a radiation polymerizable compound on an intermediate transfer body, the radiation polymerizable compound having a molecular structure including a radical polymerizable group and a cationically polymerizable group;
then irradiating the ink on the intermediate transfer body with a first radiation so that one of the radical polymerizable group and the cationically polymerizable group is selectively polymerized and cured;
then heating the selectively polymerized and cured ink to a temperature not lower than a softening point of the selectively polymerized and cured ink and not higher than a temperature above the softening point by 10° C., while transferring the selectively polymerized and cured ink from the intermediate transfer body to a recording medium; and
then irradiating the ink on the recording medium with a second radiation so that the other of the radical polymerizable group and the cationically polymerizable group is polymerized and cured.

2. The image forming method as defined in claim 1, wherein the one of the radical polymerizable group and the cationically polymerizable group selectively polymerized and cured on the intermediate transfer body is the radical polymerizable group.

3. The image forming method as defined in claim 2, wherein a percentage of a number of the radical polymerizable group in a total number of the radical polymerizable group and the cationically polymerizable group contained in the ink is 60% through 90%.

4. The image forming method as defined in claim 1, wherein a number of the radical polymerizable group in the molecular structure of the radiation polymerizable compound is one.

5. The image forming method as defined in claim 1, further comprising the step of applying an undercoat liquid containing the radical polymerizable group on the intermediate transfer body before the step of ejecting and depositing the ink on the intermediate transfer body,
wherein a dynamic surface tension γ1(0.1 s) of the undercoat liquid at a surface age of 0.1 seconds and a dynamic surface tension γ2(0.1 s) of the ink at a surface age of 0.1 seconds have a relationship of γ1(0.1 s)<γ2(0.1 s).

6. The image forming method as defined in claim 1, wherein the radical polymerizable compound includes a compound having a (meth)acryloyl group and a vinylether group, the compound being expressed as follows:
CH₂═CR—COO—R²—CH═CH—R³
where R¹ is one of a hydrogen atom and a methyl group; R² is an organic group having 2 to 20 carbon atoms; and R³ is one of a hydrogen atom and an organic group having 1 to 11 carbon atoms.

7. The image forming method as defined in claim 1, wherein in the step of irradiating the ink with the first radiation, the first radiation is radiated by one of a light-emitting diode and a semiconductor laser.

8. The image forming method as defined in claim 1, wherein in the step of irradiating the ink with the second radiation, the second radiation is radiated by an electron-beam irradiation device.

9. An image forming apparatus comprising:
an intermediate transfer body;
a liquid ejection device which ejects and deposits droplets of an ink containing a coloring material and a radiation polymerizable compound on the intermediate transfer body, the radiation polymerizable compound having a molecular structure including a radical polymerizable group and a cationically polymerizable group;
a liquid supply device which supplies the ink to the liquid ejection device;
a first radiation irradiation device which irradiates the ink having been deposited on the intermediate transfer body by the liquid ejection device with a first radiation so that one of the radical polymerizable group and the cationically polymerizable group in the ink is selectively polymerized and cured;
a heating device which heats the selectively polymerized and cured ink to a temperature not lower than a softening point of the selectively polymerized and cured ink and not higher than a temperature above the softening point by 10° C.;
a pressing device which presses the ink heated by the heating device so that the ink is transferred from the intermediate transfer body to a recording medium; and
a second radiation irradiation device which irradiates the ink having been transferred to the recording medium by the pressing device with a second radiation so that the other of the radical polymerizable group and the cationically polymerizable group is polymerized and cured.
